(19) United States
(12) Patent Application Publication
(10) Pub. No.: US 2009/0050565 A1
(43) Pub. Date: Feb. 26, 2009

(54) System and Method for Removing Contaminants From Wastewater

(76) Inventors: Harapanahalli S. Muralidhara, Plymouth, MN (US); Bingangg Liu, Plymouth, MN (US)

Correspondence Address: CARGILL, INCORPORATED, LAW/24, 15407 MCGINTY ROAD WEST, WAYZATA, MN, 55391, US

(21) Appl. No.: 11/887,812

(22) PCT Filed: Apr. 4, 2006
(86) PCT No.: PCT/US2006/012618

§ 371 Date: Oct. 3, 2007

Related U.S. Application Data
(60) Provisional application No. 60/668,305, filed on Apr. 5, 2005.

(51) Int. Cl. C02F 103/22

(52) U.S. Cl. 210/651; 210/652

(57) ABSTRACT

A system may be used to remove contaminants such as blood proteins or manure from a wastewater stream. The system may include prefiltering the wastewater stream followed by passing the wastewater stream through a reverse osmosis, nanofiltration, or ultrafiltration membrane. The permeate may be further sanitized. The water output from such a system may meet drinking water standards or may be used for secondary uses such as dust prevention and the like.

### CROSS-REFERENCE TO RELATED APPLICATIONS

This patent application claims priority to U.S. Provisional Patent Application No. 60/668,305, entitled “System and Method for Removing Contaminants from Wastewater,” filed on Apr. 5, 2005, which is expressly incorporated by reference herein in its entirety.

### BACKGROUND

Water is a basic and critical component to many aspects of human and other life. Only less than 3% of the Earth's water is fresh and most of it is in the form of polar ice or is too deep underground to reach. Many governmental agencies have warned that many areas of the world may experience severe water shortages if current levels of water consumption continue.

Even though North America has some of the largest fresh water lakes in the world and many huge rivers, there are still many challenges to providing sufficient fresh water to meet all of the continent's needs. Accordingly, it is desirable to find ways to reuse water that would otherwise be considered wastewater.

One area where it may be desirable to reclaim wastewater for reuse is in the food industry. A significant amount of water is used to prepare and process food. For example, in carcass processing facilities (e.g., poultry, beef, etc.), water may be used to clean and chill the carcass. In another example, a significant amount of water runoff near feedlots is collected in a lagoon. The water is manure laden and is therefore not considered to be useful. It would be desirable to provide a system and method that may be used to effectively and efficiently remove contaminants from wastewater from food processing facilities and/or manure laden runoff.

In carcass processing facilities, the water used to chill the carcass is cooled before the water is applied to the carcass. The cooling process consumes a significant amount of energy. Much of this energy is wasted when the water is discharged as wastewater. However, reclaiming the water for reuse to chill the carcass has previously been difficult due to the effects of the temperature of the water on the filtration processes and systems. It has also been economically undesirable to heat the water to filter it and then cool it back down again. Accordingly, it would be desirable to provide a system and process that may be used to effectively and/or efficiently remove contaminants from chilled wastewater.

### DRAWINGS

FIG. 1 shows a process flow diagram of one embodiment of a filtration system.

FIG. 2 shows a process flow diagram of one embodiment of a filtration system used to obtain the samples shown in FIG. 3.

FIG. 3 shows a number of samples treated with various filtration methods: Sample 1—raw lagoon water, left; Sample 2—80˜230 mesh sand filtrate, second from left; Sample 3—140˜500 mesh sand filtrate, third from left; Sample 4—DE filtrate, fourth from left; Sample 5—FilmTec NF 270 membrane permeate, fifth from left.

FIG. 4 shows a process flow diagram of one embodiment of a diatomaceous earth rotary vacuum filtration system.

FIG. 5 shows a process flow diagram of the process used to separate contaminants from the chilled wastewater stream in Example 3 and/or the final effluent wastewater stream described in Example 4.

FIG. 6 shows the process from FIG. 5 in more detail.

FIG. 7 shows a graph of the change in pressure (psig) over time of the wastewater stream in Example 6.

FIG. 8 shows a graph of the change in pressure (psig) over time and the change in flux rate (LMH=liter/(m̂2*hr)) over time of the wastewater stream in Example 7.

FIG. 9 shows a graph of the change in pressure (psig) over time and the change in flux rate (LMH) over time of the wastewater stream in Example 8.

FIG. 10 shows a graph of the change in pressure (psig) over time and the change in flux rate (LMH) over time of the wastewater stream in Example 9.

FIG. 11 shows a graph of the flux (LMH) versus pressure (psig) with R=1 in Example 11.

FIG. 12 shows a normalized graph of the data from FIG. 11.

FIG. 13 shows a graph of the flux (LMH) versus pressure (psig) with R=2 in Example 11.

FIG. 14 shows a normalized graph of the data from FIG. 13.

FIG. 15 shows a process flow diagram of one embodiment of a dissolved air flocculation system.

### DETAILED DESCRIPTION

Although the subject matter described herein is provided in the context of treating wastewater from carcass processing facilities and/or manure laden runoff water from feedlots, it should be understood that the concepts and features described herein may be used in a variety of settings and situations as would be recognized by those of ordinary skill in the art. Also, it should be understood, that the features, advantages, and/or characteristics of one embodiment may be applied to any other embodiment to form an additional embodiment unless noted otherwise.

In general, it is desirable to reclaim wastewater from a number of sources and reuse the water. For example, if the chilled water used to chill and rinse carcasses in carcass processing facilities can be purified without substantially raising its temperature, it can be reused as chilled water with only minimal additional cooling. This can provide a tremendous savings on energy that would otherwise be used to continually chill previously unused water. Also, the runoff water from feedlots that is presently stored in lagoons may be reused as drinking water for the cattle, dust control, etc. Certain uses such as drinking water for the cattle would require a higher level of filtration than using the water for dust control.

A number of processes are described herein which may be used to remove contaminants from wastewater to allow the resulting filtered water to be reused. In many of the processes shown herein, the wastewater is prefiltered and then filtered at least one additional time before being suitable to reuse.

There are four different classifications of membrane processes commonly used in filter applications—reverse osmosis, nanofiltration, ultrafiltration, and microfiltration. Table 1 shows the features of each membrane process. In Table 1, HMWC refers to a high molecular weight component such as a protein, and LMWC refers to a low molecular weight component such as salt and/or small organic compounds (e.g., glucose).

TABLE 1
Four types of membrane processes

| | Reverse Osmosis | Nanofiltration | Ultrafiltration | Microfiltration |
|---|---|---|---|---|
| Membrane | Asymmetrical | Asymmetrical | Asymmetrical | Symmetrical |
| | | | | Asymmetrical |
| Pore size | <0.002 microns | <0.002 microns | 0.2-0.002 microns | 4-0.02 microns |
| Rejection of | HMWC | HWMC | macro molecules | particles |
| | LMWC | mono-, di- and | proteins | clay |
| | sodium chloride | oligosaccharides | Polysaccharides | bacteria |
| | glucose | polyvalent neg. | vira | |
| | amino acids | ions. | | |
| Operating | 200-2150 | 20-500 | 0-140 | <14 |
| pressure (psig) | | | | |

Reverse osmosis (RO) is the tightest membrane in liquid/liquid separation. In principle, water is the only material that passes through the membrane so that essentially all dissolved and suspended material is rejected. In practice, there are small amounts of dissolved and suspended material that pass through the membrane. Loose reverse osmosis refers to membranes that reject more than 50% of the sodium chloride in a water stream. Also, reverse osmosis may be used to remove materials that are below 12 Angstroms in size.

Nanofiltration (NF) rejects ions with more than one negative charge, such as sulfate or phosphate, while passing single charged ions. Nanofiltration can also reject uncharged, dissolved materials and positively charged ions according to the size and shape of the molecule. In general, the rejection of sodium chloride in nanofiltration may vary from 0 to 75% depending on the feed concentration. Thus, there is some area that reverse osmosis and nanofiltration overlap. Of course, it should be appreciated that whether a particular membrane is referred to as loose reverse osmosis versus nanofiltration can vary depending on the concentration of the salt in the water. Therefore, commonly used membrane rating conditions should be referred to when determining whether a particular membrane or process should be referenced as a reverse osmosis membrane or a nanofiltration membrane. For example, one common set of conditions for rating membranes is using water having 1500 ppm of sodium chrolide, 150 psig of pressure, 77° F., pH 6.5-7.0, where the rating data is taken after 15-30 minutes of operation. Nanofiltration may be used to remove materials that are about 9 to 60 Angstroms in size.

Ultrafiltration is a process where soluble HMWCs such as protein and suspended solids are rejected, while LMWCs pass through the membrane freely. Thus, an ultrafiltration membrane generally does not reject substantial amounts of mono- and di-saccharides, salts, amino acids, organics, inorganic acids, or sodium hydroxide. Ultrafiltration may be used to remove materials that are about 25 to 1100 Angstroms in size.

Microfiltration is a process where suspended solids are primarily rejected, while even soluble proteins pass through the membrane freely. None of these cut-offs are absolute and it is often the case that some of the components which a particular membrane is designed to filter out will pass through the membrane under certain operating conditions. Microfiltration may be used to remove materials that are about 400 to 30,000 Angstroms in size.

It should be appreciated that the reference to each membrane process using the terms reverse osmosis, nanofiltration, ultrafiltration, and microfiltration does not necessary signify that hard and fast boundaries exist that define one type of membrane process from the adjacent membrane processes. Rather, each of these terms refers to a general area in a continuum of membrane processes, and adjacent membrane processes on this continuum may overlap somewhat on this continuum.

Wastewater streams from carcass processing facilities and/or manure laden runoff may be filtered in a number of different ways to provide reusable water. The wastewater stream is often, but not always, filtered using a membrane. Because of the wide variety and sizes of materials in the wastewater stream, it is often desirable to prefilter the wastewater stream in some fashion before it is filtered using a membrane and/or filtered before reuse.

The wastewater stream may be prefiltered in one or more steps. For example, a mesh screen or grate may be used as an initial filter to remove larger contaminants from the wastewater stream. A downstream sand filter, diatomaceous earth, and/or bag filter may be used to further remove larger materials from the wastewater stream. The particular prefilter selected depends on the size of the materials to be removed from the wastewater stream with appropriate consideration given to fouling propensity and required cleaning frequency of the prefilter. It should be appreciated that in some embodiments only a sand filter is used as a prefilter, while in other embodiments multiple prefilters will be used.

In one embodiment a dissolved air flotation (“DAF”) system may be used to prefilter the wastewater stream. This may be done with or without the aid of coagulating and/or flocking additives (e.g., an acrylate-acrylamide resin). The flocking additive (also referred to herein as a “flocculation agent”) may be chosen to enhance the removal of blood proteins as well as suspended solids from the incoming wastewater stream.

Flotation with or without the aid of a dissolved gas, such as air, nitrogen or carbon dioxide, is capable of being employed in the separation of solid and semi-solid mass from aqueous mixtures containing suspended solids. In a flotation operation, the mixture is allowed to separate by density differences, with adequate retention time. In such a matrix, solids which are both heavier and lighter than the liquid phase may be separated from the liquid phase. Lighter-than-liquid solids will float and can also assist heavier-than-liquid solids to float through inter-particle attraction.

Dissolved air flotation (“DAF”) employs the mixture of dissolved air into the system; this gives greater buoyancy to particles through bubble-particle interactions. DAF systems can be used to float significant quantities of heavier-than-liquid solids. A flotation system typically includes a tank, which allows a desired retention time, an inlet distribution system, baffles, a solids removal mechanism overflow and an underflow outlet. The underflow outlet can employ a weir. A DAF system will also include a dissolved air introduction system, which mixes dissolved air with a feed stream and/or a recycle stream.

The flotation tank can be of many shapes: cylindrical, horizontal, square etc. Separation can employ different vectoring movements of the solids and liquids. For instance, in a vertical flotation tank, separation is mostly performed in a vertical direction with masses moving either up or down with the feed commonly entering somewhere in the center of the system. In a horizontal flotation tank, there is introduction at one end with flow moving generally horizontally across the tank, with solids migrating to the top portion and clarified solution being removed at the bottom via an underflow outlet.

The flotation separation may be carried out using a dissolved air flotation (“DAF”) system (sometimes referred to as a bubble-flotation system). Generally, the separation of solids using a bubble-flotation system involves a number of steps. Air bubbles are introduced into a solution of suspended solids. The bubbles may either adhere to the surface of the particle or become entrapped in the particle matrix. The combined bubble/particle floats to the surface, the clarified liquor remains toward the bottom of the mixture. The concentrated solids are typically removed from the surface via a skimming operation.

One of the major design requirements of such systems is to get as small of a bubble size as possible. Dissolved air flotation is a commonly employed method where air is dissolved into a clarified stream under pressure. When pressure is released into feed material, the air comes out of solution and forms tiny micro bubbles. A properly designed air addition system may be able to generate bubbles as small as down to about 40 micrometers.

Flotation technology is used in many industries. For example, it has been used in oil refineries to assist in separation of entrained oil particles from water. This is an ideal application because of the extreme hydrophobicity of the oil particles and the lower density of the oil. Flotation can be particularly effective to remove particles that contribute to high turbidity as well as color bodies. One large application for flotation is in the mining industry. Here flotation is used to remove suspended crushed rock from water and for separation of certain types of ores. It was discovered that certain types of minerals preferentially float due to a higher bubble-particle adhesion properties. In this way, more desirable ores can be separated and concentrated. Coagulation and flocculation are often used to assist the flotation.

Several models have been built to predict the effects of flotation. Typically, a float cell is divided into two parts. The “reaction zone” is where the feed is introduced to a bubble-enriched recycle stream and the “separation zone” is where the actual separation of material takes place. Two factors influence the performance of the flotation cell. The first, Xn, is defined as the contact bubble-particle efficiency. It is the fraction of particles entrained in bubbles in separation zone. It has been derived as being described by the following equation:

$$X = 1 - {e}^{- \frac{( a - pb ) ( nr ) ( bd ) ( g )}{12 ( u ) ( sb )}}$$

where:
a-pb=the bubble-particle adhesion factor
nr=the bubble-particle collision factor
bd=the bubble density
g=gravitational constant
u=fluid viscosity
sb=bubble size

In order to maximize the efficiency of formation, the exponential factor should be maximized. This means the following:

Maximize the bubble-particle adhesion factor. This factor is a function of the surface interactions between bubbles and the particles. In general, experiments have shown that bubbles have a fairly high negative surface charge. It has also been shown that more hydrophobic particles adhere to bubbles more easily. In order to increase this factor, chemical agents can be added to make the surface of the particles more hydrophobic. Usually, positively charged surfactants or coagulants are used to counteract the negatively charged surface of the bubbles. Also, coagulants are commonly used to help increase the particle size and entrap smaller particles in the floc.

Maximize the bubble-particle collision factor. This factor measures the probability of bubbles colliding with particles. Generally, it is thought of in three cases with three separate factors that are added together. The first case is particle sizes much greater than the bubbles, where multiple bubbles attach to the particle. This is usually the dominating force when floating flocculated material. The second case is where the bubble is on the same relative size scale as the particle. The bubble cannot be “entrapped” in the particle and must be physically attached. The third case is where the bubble is much larger than the particle, and here Brownian diffusion is the most relevant force.

Most wastewater and water treatment facilities rely on the first case where the flocculated particle is much larger than the bubble. For this case, the larger the particle the better. Flocculants are usually added to increase particle size. For the second and third case, increasing the probability of collision is the easiest way to increase this factor. This can entail increasing the retention time in the reaction zone or the turbulence. Unfortunately, increasing turbulence in reaction zone usually does more harm than good because it can destroy the delicate floc structure. Because of this, turbulence is commonly minimized in the reaction zone.

Maximize the bubble volume concentration. Since the amount of air that can dissolve in water is fixed, the only way this number can be effectively increased is by increasing the saturation pressure or increasing the recycle rate. The higher the separation pressure, the more air can be dissolved in it. Practically speaking, going above 400 kPa has diminishing returns. Since the air is dissolved in a clarified recycle stream, increasing this flowrate will increase bubble volume density. It also takes away from the stream of clarified underflow, which decreases the effective throughput for the system.

Another factor which governs efficiency of a dissolved air flotation cell is the ability of the bubble-particle conglomerate to reach the surface. This factor is denoted as Yn and is defined as the agglomerate separation efficiency factor. In effect, the rise time of the bubble-particles must be larger than the net residence time in the separation zone. Since the bubble/particle conglomerate can have a range of sizes, there will be a range of rise times. The agglomerate separation efficiency factor is usually a geometric design parameter of the flotation cell. In general, flotation cells are rated on their “surface loading” where the surface loading (UL) is defined as the volumetric flow rate of the system (QL) divided by the overall cross sectional area (AL) or:

UL=QL/AL

DAF flotation cells generally operate successfully when the rise velocity of the bubble-particle conglomerate (UR) is greater than the surface loading rate (UL). Other geometric and practical considerations can also effect Yn. The “dead space” in the separation zone (m) is an area of the tank where no separation takes place. The dead space effectively reduces the size of the separation zone. It can also contribute to convection currents, another detrimental effect for flotation cells. It is desirable to have laminar, even flow in the separation zone. Anything that causes deviations from this condition can decrease the effectiveness of a flotation cell. In general, it is desirable to have a design where flow is not turbulent (low Reynolds number), eddy currents are minimized (low Peclet number) and flow distribution is as even as possible (low % dead space). For a given design, all three factors are usually increased with increasing flow rate.

The overall separation efficiency (E) of a flotation cell is equal to the filter efficiency factor Xn multiplied by the agglomerate separation efficiency Yn, or

E=Xn×Yn

In order to maximize flotation cell efficiency, one must consider a reasonable, cost effective approach to maximize the ability for bubbles and particles to interact and to provide the most cost effective geometrical considerations for the flotation cell.

Several factors are commonly taken into account in the design of a flotation cell. There are several theoretical as well as practical considerations. A number of these are discussed below.

Air dissolve system. For good flotation, an air dissolve system is commonly designed where the bubble size is minimized and uniform and the bubble concentration is as high as possible. Theoretically, the bubble concentration is limited by the amount of air that will dissolve at the saturation pressure. The best systems reported in the literature have median bubble sizes at about 40 microns, with a distribution of bubble sizes from about 10-100 microns. For better results, it is desirable to have a tight distribution curve of bubble sizes and as small as possible. This is usually most effectively accomplished by the injection nozzle design and the saturation system. A pressurization tank is useful to remove macro-bubbles on the pressurized system. The final major factor for air dissolve system is the saturation efficiency. This is a measure of the amount of air that becomes dissolved in the recycled stream divided by the theoretical limit determined from Henry's law. In practice, real efficiencies range from about 70-90%. Methods used to increase the air dissolve efficiency usually aim at increasing the amount of contact time between the air and the recycled liquid in the air dissolve tank. Using a packed column design seems to be the most popular method of increasing this contact time.

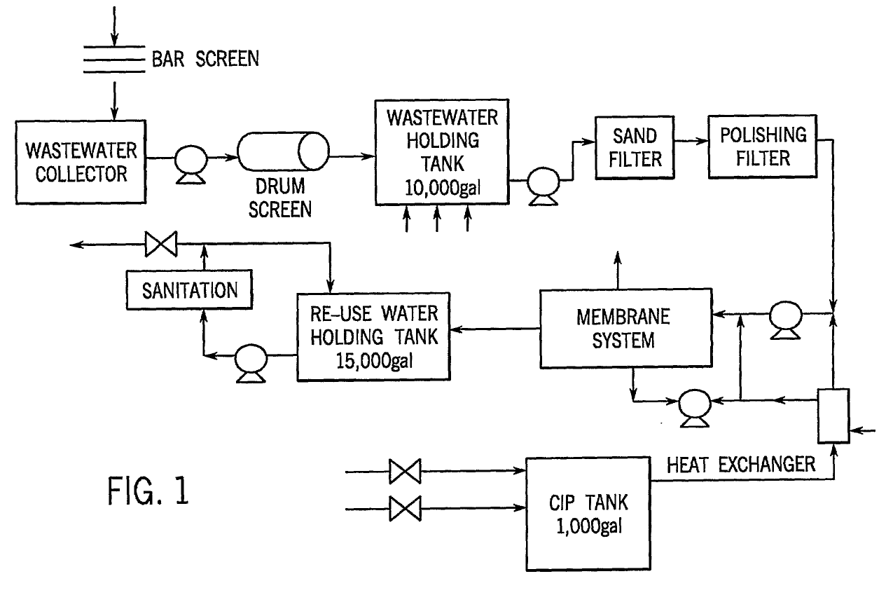

Tank design. One of the more important factors for designing an effective DAF is the tank design. For a good design, the tank should desirably have as little dead space as possible, an appropriate surface loading ability, as little turbulence as possible, good distribution of flow, and a length to diameter ratio that is appropriate for the separation. Dynamic velocity tests have been performed on a rectangular unit and have shown that for a particular design, turbulence and eddy currents typically will increase as the flow through the cell increases. This in effect lessens the separation ability of the cell by “short-circuiting”the separation zone or causing turbulence in the separation zone. This effect can be lessened by employing better distribution techniques such as baffling or lateral distribution systems. There are a few designs described in literature that lessen the distribution problems from the classical rectangular tank. One is a “coaxial” design where the reaction zone is introduced into the tank though an annular rise pipe in the center of the tank (see, e.g., the flotation system depicted in FIG. 1). The mixture rises to the top of the annulus and then flows downward through the outside of the annulus. The bubble/particle floc floats to the top of the tank and is skimmed off. Surface loading has been reported to increase by about 50% for this design compared to the rectangular tank.

Skimmer design. The skimmer of a flotation cell is a design characteristic that is frequently overlooked. If improperly designed, particles can become detached from the bubble and fall back into solution. This effectively increases the necessary separation zone. Also, properly designed skimmers can decrease the moisture content of the floated solids. Using a “brush” type arm with a sloped beach before solids discharge has been reported to increase solids content by 1% dissolved solids (“DS”).

Process scale-up. A few studies have focussed on scaling up a pilot unit and compare results to full scale unit. Scale-up is usually followed by designing the tank to have similar surface loading rates, L/D ratios, Peclet number, and Reynolds number of the pilot unit. Usually the efficiency of a full scale plant is at or slightly below that of a corresponding pilot plant. This is generally assumed to be due to the hydrodynamic effects from increased volumes. To counteract this, baffling and distribution systems may be used. In some cases, several smaller units in parallel have been used to increase the system efficiency and flexibility.

After prefiltering the wastewater stream, a nanofiltration or reverse osmosis membrane is used to further filter the wastewater. For example, chilled wastewater in a carcass processing facility may be filtered using a nanofiltration or reverse osmosis membrane to provide water than can be reused in the facility as spray chill water.

In one embodiment, a poultry carcass processing facility may use a wastewater filtration system to provide reusable water for the facility. The wastewater stream may be either the final effluent stream of the entire facility or may be the wastewater stream from a particular process such as the spray chill process. If the wastewater stream is a chilled wastewater stream, the temperature of the wastewater stream may be no more than about 55° F., 50° F., 45° F., or, desirably, 40° F.

The wastewater stream in the poultry processing facility often contains blood proteins, in particular avian blood proteins. In general, the wastewater stream may include at least about 1000 ppm, 1500 ppm, or 2000 ppm suspended solids having a particle size less than 1 microns, 0.5 microns, or, desirably, 0.1 microns.

The wastewater stream may be prefiltered by passing the wastewater stream through a sand filter and/or a microfiltration membrane. The microfiltration membrane may have a pore size of about 0.5 to 2 microns and a filtering surface with a contact angle of no more than about 40 degrees. The microfiltration membrane may also be a polymeric membrane that comprises nylon and/or polypropylene. In another embodiment, the microporous membrane may have a filtering surface with a contact angle between about 35 and 40 degrees.

The permeate from the microfiltration membrane may then be passed through a nanofiltration membrane. The nanofiltration membrane may be a polyamide membrane that has a filtering surface with a contact angle of no more than 40 degrees. The permeate from the nanofiltration membrane may be sanitized and reused in a variety of ways. In those situations where the wastewater stream includes chilled wastewater, the permeate from the nanofiltration membrane may also be chilled. For example, the temperature of the permeate from the nanofiltration membrane may be no more than about 70° F., 60° F., 55° F., or 50° F.

In another embodiment, a beef cattle carcass processing facility may use a wastewater filtration system to provide reusable water for the facility and/or for other uses. The wastewater stream may be either the final effluent stream of the entire facility or may be the wastewater stream from a particular process such as the spray chill process. If the wastewater stream is a chilled wastewater stream, the temperature of the wastewater stream may be no more than about 55° F., 50° F., 45° F., or, desirably, 40° F.

The wastewater stream in the carcass processing facility may include blood proteins, in particular bovine blood proteins. The wastewater stream may include at least about 500 ppm, 750 ppm, or, 1000 ppm of blood proteins. Also, the wastewater stream may have a temperature that is no more than about 70° F. The wastewater stream may include at least about 400 ppm or 500 ppm suspended solids and have a bicarbonate alkalinity of about 300-350 ppm. Further, the wastewater stream may include at least about 10 ppm or, commonly about 30 to 100 ppm of oil and grease.

The chilled wastewater and/or final effluent from the carcass processing facility may be pretreated before being filtered using membranes with coagulants/flocculants such as alum. Pretreatment using coagulation/flocculants may serve to reduce the amount of blood protein and/or other biological molecules that may foul the membranes. In addition to coagulants/flocculants, the chilled wastewater and/or other effluent stream may also be pretreated by filtering the wastewater using one or more layers of mesh screen, filter bags or sand filters. In one embodiment, a 50 micron or, desirably, 100 micron bag filter may be used to filter the chilled wastewater and/or the effluent wastewater stream.

The prefiltered wastewater stream may then be passed through an ultrafiltration membrane to remove additional impurities. The ultrafiltration membrane may be any suitable membrane. In one embodiment, the ultrafiltration membrane may have no more than a 10K molecular weight cut-off (MWCO) at 50 psig. The permeate from the ultrafiltration membrane may have a protein content of no more than about 15 ppm, 10 ppm, or 5 ppm.

The permeate from the ultrafiltration membrane may then be passed through a reverse osmosis membrane to remove additional impurities including unwanted molecules and microbiological matter. The reverse osmosis membrane may include a polyamide material and may have a NaCl rejection rate of at least about 99%. The resulting permeate from the reverse osmosis membrane may be sufficiently pure to meet the requirements for reuse water as indicated by the United States Department of Agriculture in Table 3 below. If the wastewater stream is a chilled wastewater stream, then the temperature of the permeate from the reverse osmosis membrane may be no more than about 70° F., 60° F., 55° F., or 50° F.

In another embodiment, wastewater that includes animal manure (e.g., cattle manure) may be filtered to provide reusable water. The wastewater stream may include at least about 5,000 ppm, 8,000 ppm, or 10,000 ppm of suspended solids. The wastewater stream may also include at least about 5,000 ppm, 8,000 ppm, or 10,000 ppm of suspended solids having a particle size between about 0.1 to 1 microns.

The wastewater stream may be prefiltered using a sand filter. In one embodiment, the sand filter has a mesh size that is about 50 to 200 or 120 to 180 for smaller particles and about 180 to 800 or 400 to 700 for larger particles. After passing through the sand filter, the filtered wastewater stream may include no more than about 3000 ppm or, desirably, 2000 ppm suspended solids.

The filtered wastewater stream from the sand filter may then be filtered using another filter. In one embodiment, the next filter may be a diatomaceous earth vacuum filtration system. The diatomaceous earth acts to remove additional impurities from the filtered wastewater stream. In on embodiment, the filtered wastewater stream includes no more than about 500 ppm, 100 ppm, or, desirably, no more than 10 ppm suspended solids. The filtered wastewater stream may be sanitized using ozone or ultraviolet light and used for dust control (e.g., spraying the water on the ground) at the carcass processing facility.

It should be appreciated that a nanofiltration membrane may also be used after or in place of the diatomaceous earth filter. The filtered wastewater stream may be passed through the nanofiltration membrane under a transmembrane pressure of no more than about 35, 75, or 150 psig. In one embodiment, the nanofiltration membrane has a filtering surface with a contact angle of no more than about 40 degrees. The nanofiltration membrane may be a polyamide thin-film composite type membrane. The rejection rate of MgSO4 of the nanofiltration membrane may be at least about 90%, 95%, or 97%. The use of the nanofiltration membrane may be particularly desirable in those instances where the water is to be reused for cattle drinking, etc. Water used for dust control may not need to be filtered as much as water used for drinking or washing.

The manure byproduct of the filtering process may be collected and used as fertilizer. Thus, not only is the water being reused, but the nutrients in the manure are also capable of being reused.

As used herein, “MgSO4 rejection rate” shall refer to the percentage of MgSO4 that is unable to pass through a membrane from a stream having a MgSO4 loading of 2000 ppm at 70 psig, 25° C., and 15% recovery. As used herein, “CaCl2 rejection rate” shall refer to the percentage of CaCl2 that is unable to pass through a membrane from a stream having a CaCl2 loading of 500 ppm at 70 psig, 25° C., and 15% recovery. As used herein, “NaCl rejection rate” shall refer to the percentage of NaCl that is unable to pass through a membrane from a stream having a NaCl loading of 1500 ppm at 150 psig, 25° C., and 15% recovery.

### EXAMPLES

The following examples are provided to further describe the subject matter disclosed herein. The following examples should not be considered as being limiting in any way.

### Example 1

The process shown in FIG. 1 is used to remove contaminants from wastewater produced in a poultry carcass processing facility. The wastewater stream that enters the bar screen includes water used to rinse turkey carcasses during processing. An analysis of the wastewater stream is shown in Table 2. The wastewater stream includes a number of contaminants including poultry blood protein. The temperature of the wastewater stream may vary from 40° F. to 90° F. depending on the season of the year.

The method used to remove contaminants from the wastewater stream includes passing the wastewater stream through a number of prefilters. The prefilters include a bar screen, a drum screen, a sand filter, and a polishing filter. The wastewater stream is passed through a microporous membrane having pores that are about 1 micron in size. The microporous membrane is a polymer membrane (i.e., nylon or polypropylene) that has a filtering surface with a contact angle of about 35 to 40 degrees.

TABLE 2
Wastewater Analysis

| ANALYTE | RESULT |
|---|---|
| BOD5 (ppm) | 93 |
| COD (ppm) | 291 |
| TDS (ppm) | 112 |
| TSS (ppm) | 86 |
| TOC (ppm) | 35 |
| Oil and Grease (ppm) | 65 |
| TKN (ppm) | 26.3 |
| Ammonia N (CFU/ml) | 0.3 |

After prefiltering, the wastewater stream is passed through a filtration system that includes a low pressure nanofiltration membrane. The low pressure nanofiltration membrane can be obtained from Dow Chemical Company under the trade name FilmTec NF270. The FilmTec NF270 membrane is a polyamide thin-film composite membrane that has a filtering surface with a contact angle of no more than 40 degrees. Also, the FilmTec NF270 has a MgSO4 rejection rate of at least about 97% and a CaCl2 rejection rate of about 40-60%.

Table 3 shows a comparison of the treated wastewater from the poultry processing facility processed according to the method described above to the USDA's requirements. The wastewater from the process shown in FIG. 1 can be used to provide reuse water in the poultry processing facility that meets the USDA's requirements.

TABLE 3

| | Reuse Water | USDA Requirements |
|---|---|---|
| TOC (mg/L) | 2.7~4.5 | 100 |
| TPC (CFU) | 0~260 | <500 |
| Total Coliform | N.D. | None |
| E. Coli | N.D. | None |
| Turbity | most samples < 0.2 NTU | No more than 5% of |
| | No sample >= 1 NTU | samples >= 1 NTU |
| Heavy Metals | Meet EPA standards | EPA standards |

### Example 2

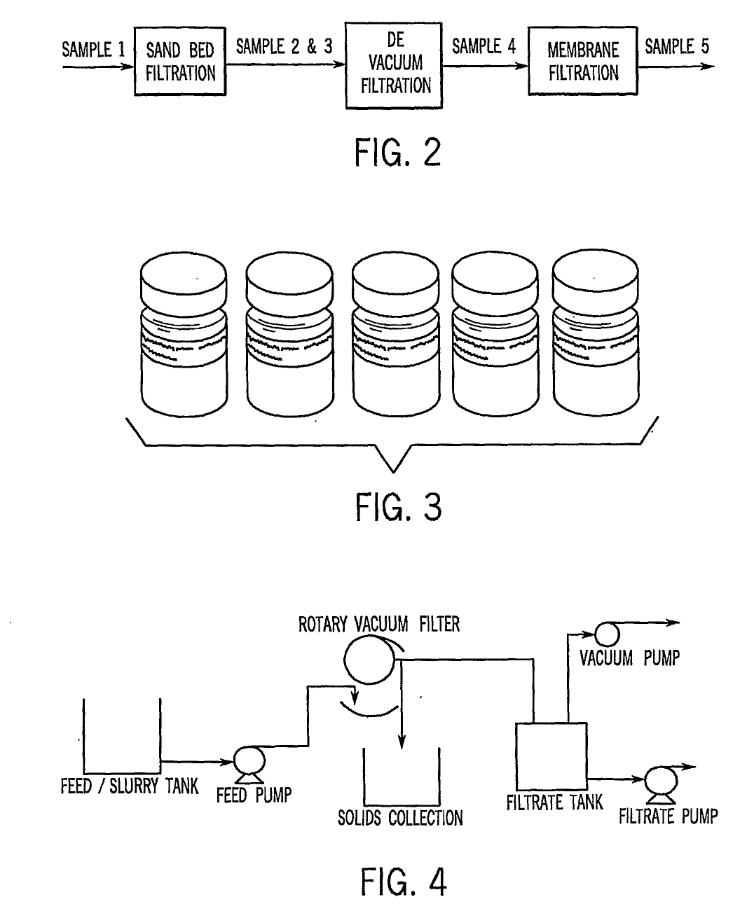

In this example, manure laden water is filtered using different successive filters as shown in FIG. 2. The manure laden water is from a lagoon that collects runoff from a cattle feedlot. The loading of the raw lagoon water is shown in Table 4 below.

TABLE 4
Lagoon Water Analysis Results

| ANALYTE | RESULT |
|---|---|
| BOD (ppm) | 1979 |
| COD (ppm) | 8105 |
| TDS (ppm) | 6592 |
| TSS (ppm) | 11680 |
| TKN (ppm) | 476 |
| Total PO4 (ppm) | 0.09 |
| SPC (CFU/ml) | 80000 |

In this example, filter beds of different filtration media are built in large vacuum funnels on filter papers. The lagoon water is filtered with sand of 80˜230 mesh, 140˜500 mesh, Diatomaceous Earth (DE) and/or a nanofiltration membrane. The pictures of the filtrate samples by the various filtration media are shown in FIG. 3.

As shown in FIG. 3, the majority of the colored particles in the lagoon water can pass through the sand bed built with sand of 80˜230 mesh (Sample 2 in FIG. 3). When filtered with 140˜500 mesh sand bed (Sample 3 in FIG. 3), it is observed that the filtrate has a light brown to yellow color. The color is very light initially and becomes darker as the filtration process proceeds. This means that while the majority of the particles are blocked at the surface of the sand bed, a portion of the particles with the sizes in the range of the sand (80˜230 mesh in this case) pass through the top surface of the filter bed and are blocked in the filter bed. As the filtration process continues, the sand bed becomes saturated with the particles and eventually the particles sizes in this range pass through the sand bed and into the filtrate.

The filtrate from the 140˜500 mesh sand bed is filtered using Diatomaceous Earth (DE) (Engelhard F-160) in a rotary vacuum filtration process. Similar phenomena is observed for the diatomaceous earth system except that the filtrate has a lighter color than the filtrate from the 140˜500 mesh sand bed. Initially, the filtrate from the diatomaceous earth system is observed to not have any color. As the diatomaceous earth becomes saturated with the particles of the same size range as diatomaceous earth, the filtrate starts to show a light yellow color (Sample 4 in FIG. 3). The loading of the water before and after diatomaceous earth filtration is shown in Table 5 below. The water before diatomaceous earth filtration is the water that resulted for the filtration in the 140˜500 mesh sand bed.

TABLE 5

| ANALYTE | Before DE Filtration | After DE Filtration |
|---|---|---|
| TSS (ppm) | 1480 | ND |
| BOD (ppm) | 510 | 71.2 |
| COD (ppm) | 4470 | 648 |
| TOC (ppm) | 1190 | 217 |

The filtration resistance increases rapidly as the filtration process started in the diatomaceous earth vacuum filtration process. This happens because there is a significant portion of very fine particles in the wastewater that forms a film on top of the filter bed and blocks the way of filtrate. In order to keep filtration process going, a scraper is used to scrape the film formed by the wastewater particles on the top of filter bed. The filtrate from the diatomaceous earth filtration system may be disinfected and used for purposes such as dust control. FIG. 4 shows a process diagram for the diatomaceous earth rotary vacuum filtration system.

As shown in FIG. 2, a Sepa Cell membrane unit is used for filtering the lagoon water. The membrane unit includes a nanofiltration membrane which is used to filter contaminants from the wastewater. Sample 5 in FIG. 3 is the permeate of the nanofiltration membrane fed with the lagoon water after sand filtration and diatomaceous earth filtration. The membrane used in this process can be obtained from Dow Chemical as model FilmTec NF270. The permeate of the FilmTec NF270 membrane fed cannot be observed to have any color by the naked eye.

### Example 3

A chilled wastewater stream from a beef cattle carcass processing facility is obtained from well water that is subsequently chilled and sprayed on beef cattle carcasses as part of the carcass processing. Table 6 shows the composition of the well water before being used in the carcass processing facility.

TABLE 6
Well Water Analysis

| ANALYTE | RESULT (ppm) | METHOD |
|---|---|---|
| Alkalinity, Bicarbonate | 390 | SM 2320 B |
| Alkalinity, Carbonate | <1 | SM 2320 B |
| Bromide, Total | 0.36 | EPA300.0 |
| Chloride, Total | 87 | EPA300.0 |
| Fluoride, Total | 0.62 | EPA300.0 |
| Barium, Total | 0.019 | EPA200.7 |
| Calcium, Total | 220 | EPA200.7 |
| Magnesium, Total | 29 | EPA200.7 |
| Potassium, Total | 14 | EPA200.7 |
| Silicon, Total | 6.2 | EPA200.7 |
| Sodium, Total | 120 | EPA200.7 |
| Nitrogen, Ammonia | <0.05 | SM4500-NH3 H |
| Nitrigen, Nitrate | 9 | EPA300.0 |
| Phosphorus, Total | 0.03 | SM4500-P E |
| Sulfate | 960 | EPA300.0 |

The chilled wastewater stream is initially dark red in color because it contains bovine blood. The suspended solids in the chilled wastewater stream are mainly blood protein, debris, and fat. The composition of the chilled wastewater stream is shown in Table 7.

TABLE 7
Chilled Wastewater Stream

| ANALYTE | RESULT | | METHOD |
|---|---|---|---|
| Alkalinity, Bicarbonate | 320 | ppm | EPA310.1 |
| Alkalinity, Carbonate | 0 | ppm | EPA310.1 |
| BOD, 5D | 2543 | ppm | SM5210B |
| Calcium, Total | 240 | ppm | EPA200.7 |
| COD | 4750 | ppm | EPA410.4 |
| E. Coli | 161 | MPN | SM9223 |
| Magnesium, Total | 56 | ppm | EPA200.7 |
| Nitrogen, Ammonia | 46.6 | ppm | SM4500-NH3 H |
| Nitrogen, Kjeldahl, Total | 667 | ppm | EPA351.2 |
| Oil and Grease | 31 | ppm | EPA1664A |
| Plate Count | 16000 | cfu/ml | SM9215B |
| Solids, Total Dissolved | 2700 | ppm | EPA160.1 |
| Solids, Total Suspended | 509 | ppm | SM 2540 D |
| Sulfate | 760 | ppm | EPA375.2 |
| Total Coliform | >24192 | MPN | SM9223 |
| Total Organic Carbon | 950 | ppm | SM5310C |

### Example 4

Final effluent wastewater stream from a beef cattle carcass processing facility is the combination of all or substantially all of the wastewater from the facility. Tables 8 and 9 show the composition of the final effluent wastewater stream at the beef cattle carcass processing facility.

TABLE 8
Final Effluent wastewater

| | | | Method | | |
|---|---|---|---|---|---|
| Test Name | Result | Units | Name | MCL | MDL |
| Aluminum, Total | <0.05 | ppm | EPA 200.7 | [0.05-0.2] | |
| Antimony, Total | <0.001 | ppm | EPA 200.8 | 0.006 | 0.001 |
| Arsenic, Total | <0.001 | ppm | EPA 200.8 | 0.05 | 0.001 |
| Barium, Total | 0.036 | ppm | EPA 200.7 | 2.0 | 0.005 |
| Beryllium, Total | <0.001 | ppm | EPA 200.8 | 0.004 | 0.001 |
| Cadmium, Total | <0.0006 | ppm | EPA 200.8 | 0.005 | 0.0003 |
| Calcium | 250 | ppm | EPA 200.7 | | 0.002 |
| (Carbonate) | | | | | |
| Chloride | 170 | ppm | EPA 300.0 | [250] | |
| Copper, Total | <0.005 | ppm | EPA 200.7 | 1.3 | 0.005 |
| Fluoride | 0.44 | ppm | SM | 4.0 | 0.1 |
| | | | 4500- | | |
| | | | F-C | | |
| Iron, Total | 0.043 | ppm | EPA 200.7 | [0.3] | 0.01 |
| Lead, Total | <0.001 | ppm | EPA 200.8 | 0.015/90% | 0.001 |
| Magnesium, Total | 25 | ppm | EPA 200.7 | | 0.02 |
| Manganese, Total | 0.013 | ppm | EPA 200.7 | [0.05] | 0.002 |
| Mercury, Total | <0.0001 | ppm | EPA 245.1 | 0.002 | .0001 |
| Nitrate/Nitrite-N | 150 | ppm | EPA 353.2 | 10 | 0.3 |
| Nitrite-N | 0.04 | ppm | SM | 1.0 | 0.02 |
| | | | 4500- | | |
| | | | NO2-B | | |
| Phosphate, Total | 85 | ppm | EPA 365.1 | | 0.01 |
| Potassium, Total | 63 | ppm | EPA 200.7 | | 0.03 |
| Selenium, Total | 0.002 | ppm | EPA 200.8 | 0.05 | 0.001 |
| Silicon (silicates), | 6.7 | ppm | EPA 200.7 | | 0.02 |
| Total | | | | | |
| Sodium, Total | 290 | ppm | EPA 200.7 | | 0.2 |
| Solids, Dissolved | 1700 | ppm | SM 2540 C | [500] | 10 |
| Solids, Suspended | <10 | ppm | SM 2540 D | [500] | 10 |
| Sulfate | 190 | ppm | EPA 300.0 | | 3 |
| Thallium, Total | <0.001 | ppm | EPA 200.8 | 0.002 | 0.001 |
| Zinc, Total | 0.11 | ppm | EPA 200.7 | [5.0] | 0.01 |

TABLE 9
Final Effluent

| ANALYTE | RESULT (ppm) | METHOD |
|---|---|---|
| Alkalinity, Bicarbonate | 46 | SM 2320 B |
| Alkalinity, Carbonate | <1 | SM 2320 B |
| BOD, 5D | 3 | SM5210 B |
| Bromide, Total | 0.3 | EPA300.0 |
| Chloride, Total | 180 | EPA300.0 |
| COD | 54 | SM5220 D |
| Fluoride, Total | 0.46 | EPA300.0 |
| Barium, Total | 0.04 | EPA200.7 |
| Calcium, Total | 72 | EPA200.7 |
| Magnesium, Total | 16 | EPA200.7 |
| Potassium, Total | 43 | EPA200.7 |
| Silicon, Total | 7 | EPA200.7 |
| Sodium, Total | 200 | EPA200.7 |
| Nitrogen, Ammonia | 0.92 | SM4500-NH3 H |
| Nitrigen, Nitrate | 140 | EPA300.0 |
| pH | 7.49 s.u. | SM4500-H B |
| Phosphorus, Total | 32 | SM4500-P E |
| Solids, Total Suspended | <5 | SM 2540 D |
| Sulfate | 120 | EPA300.0 |
| Turbidity | 2.2 NTU | SM 2130 B |

### Example 5

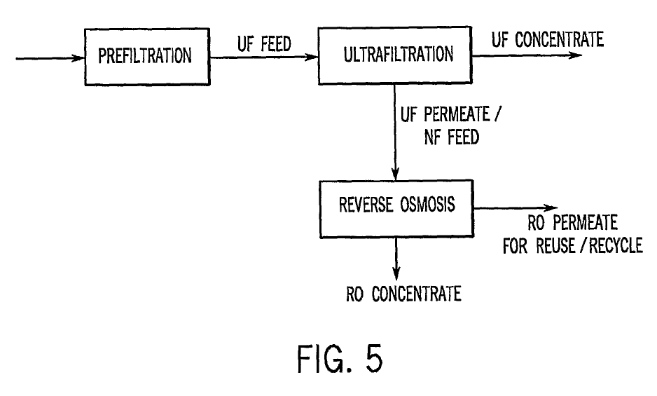

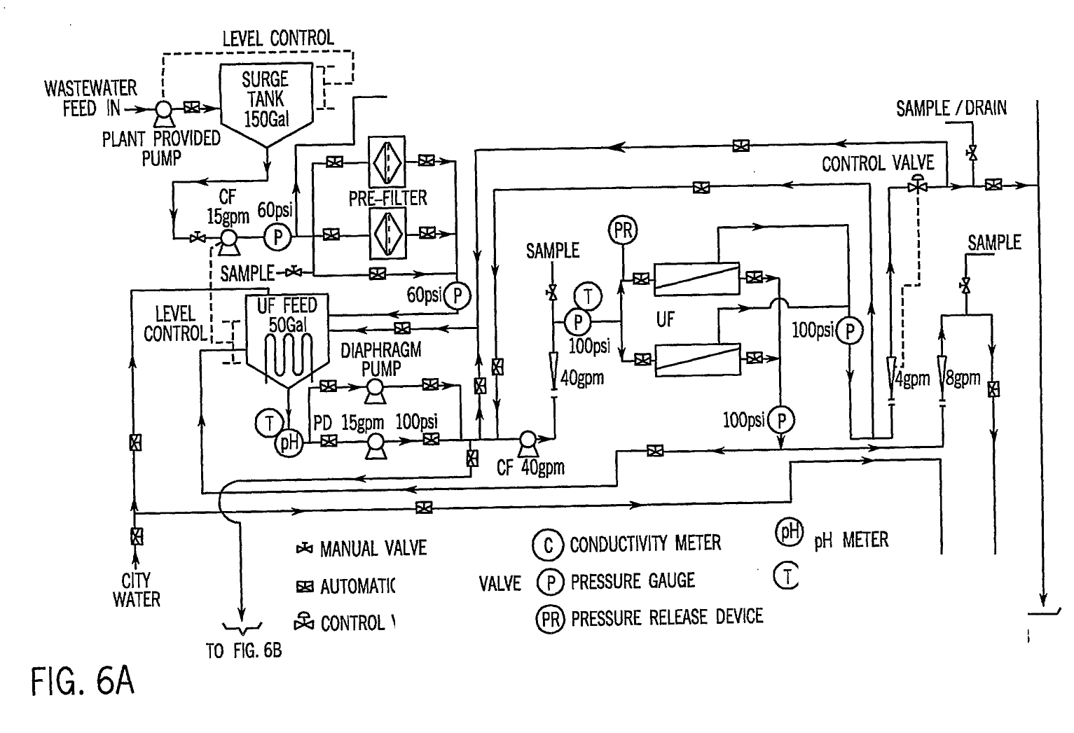

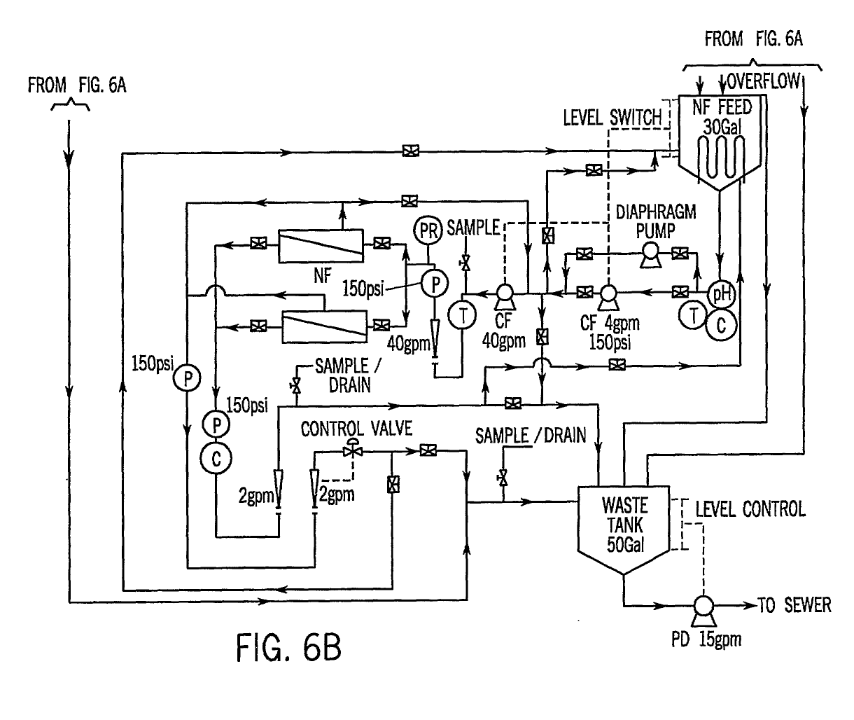

FIG. 5, shown below, is a process diagram of a process used to separate contaminants from the chilled wastewater stream described in Example 3 and/or the final effluent wastewater stream described in Example 4. A more detailed process diagram is shown below in FIG. 6.

The processes shown in FIGS. 5 and 6 include prefiltration of the wastewater stream, followed by ultrafiltration and reverse osmosis filtration. The ultrafiltration membrane was placed before the reverse osmosis membrane to remove the suspended solids in the wastewater. The whole system was operated at ambient temperature. The transmembrane pressure across the reserves osmosis membrane was typically between 100 and 200 psig, and the transmembrane pressure across the ultrafiltration membrane was typically below 50 psig.

### Example 6

The chilled wastewater stream from Example 3 was filtered using the process described in Example 5 up through the ultrafiltration step. A mesh screen was used to prefilter the chilled wastewater stream. UF Membrane A (i.e., available from Hydranautics as model JT1) was used to filter the chilled wastewater stream at different feed flowrates and concentration factors (CF).

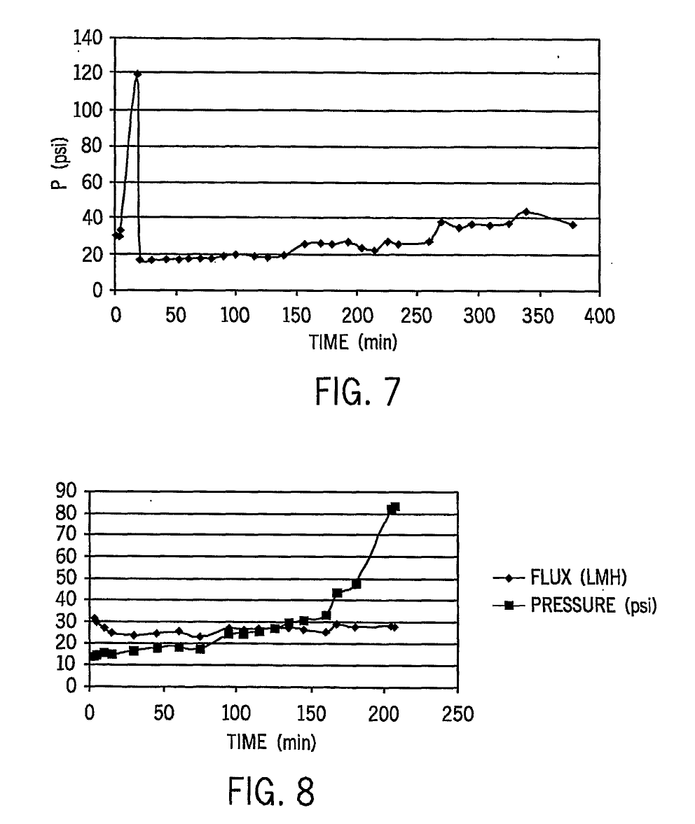

Table 10 shows the result using Membrane A operating at a CF ranging from 2 to 10, or permeate to concentrate ratio (R) from 1 to 9 (R=CF−1). The system was operated at R=1 and feed flowrate around 1400 liter/hr (6.2 gpm). The feed water temperature was mainly in the range of 14° C. to 16° C. The feed pressure went up from 30 psig to 120 psig in less than 20 minutes at this flowrate. The system was stopped and restarted shortly at a much lower feed flowrate (around 450 liter/hr, or 2 gpm) and R=2. The system was then running continuously for 6 hours with the ratio being increased from time to time. It was found that the feed flowrate affects the stable running of the UF system. The feed flowrate of the system was in the range of 1 to 2 gpm with the high end when running at lower ratio and the low end at higher ratio. The permeate flux was normally in the range of 10-20 LMH and the average feed pressure in the range of 20 to 40 psig. The change of feed pressure during the test is shown in FIG. 7.

TABLE 10
UF Membrane A on Spray Chill
30 mils feed spacer, mesh screen

| Time | Permeate flux | Feed flowrate | Feed Pressure | Norm. flux | | Sweeping velocity |
|---|---|---|---|---|---|---|
| (min) | (LMH = L/(m\hat{ }2 * hr)) | (Liter/Hr) | (psig) | (liter/m\hat{ }2 · hr · psig) | Ratio | (GPM = gal/min) |
| 1 | 51.3 | 1465 | 30.3 | 1.70 | 1.1 | 26 |
| 3 | 44.4 | 1452 | 30 | 1.47 | 0.8 | 12 |
| 4 | 46.7 | 1386 | 33.3 | 1.40 | 1 | 10 |
| 18 | 47.7 | 1444 | 120 | 0.40 | 1 | |
| 20 | 20.7 | 469 | 16.9 | 1.23 | 1.9 | 10 |
| 30 | 19.6 | 441 | 16.9 | 1.16 | 1.9 | 10 |
| 42 | 18.7 | 417 | 17.1 | 1.09 | 2 | 10 |
| 52 | 17.8 | 400 | 17.2 | 1.03 | 1.9 | 10 |
| 60 | 17.4 | 387 | 17.7 | 0.99 | 2 | 10 |
| 70 | 17.4 | 392 | 17.5 | 0.99 | 1.9 | 10 |
| 80 | 16.9 | 376 | 17.9 | 0.94 | 2 | 10 |
| 90 | 16.7 | 330 | 19.3 | 0.86 | 2 | 10 |
| 100 | 16.2 | 318 | 19.6 | 0.83 | 3 | 10 |
| 115 | 15 | 297 | 19.2 | 0.78 | 3 | 10 |
| 125 | 13.9 | 275 | 18.2 | 0.76 | 3 | 10 |
| 140 | 13.9 | 264 | 19.6 | 0.71 | 3.6 | 10 |
| 157 | 15.7 | 294 | 25.9 | 0.60 | 3.9 | 20 |
| 170 | 14.8 | 275 | 26.3 | 0.57 | 4.1 | 20 |
| 180 | 14.3 | 264 | 26 | 0.55 | 4 | 20 |
| 193 | 14.1 | 264 | 27.1 | 0.52 | 4 | 20 |
| 204 | 12.8 | 220 | 23.9 | 0.53 | 6.4 | 10 |
| 214 | 11.7 | 205 | 22.2 | 0.53 | 5.8 | 10 |
| 225 | 12.8 | 220 | 27.3 | 0.47 | 6.4 | 20 |
| 235 | 12.3 | 213 | 25.5 | 0.48 | 6.1 | 20 |
| 260 | 12.3 | 210 | 26.9 | 0.45 | 6 | 20 |
| 270 | 13.6 | 226 | 37.9 | 0.36 | 8.2 | 20 |
| 285 | 12.4 | 205 | 35 | 0.36 | 9.7 | 20 |
| 295 | 12.3 | 205 | 36.4 | 0.34 | 8.4 | 20 |
| 310 | 11.9 | 199 | 36.2 | 0.33 | 8.1 | 20 |
| 325 | 11.5 | 190 | 37.1 | 0.31 | 9 | 20 |
| 340 | 12.6 | 210 | 43.8 | 0.28 | 8.6 | 20 |
| 378 | 9.7 | 289 | 36.6 | 0.27 | 1 | 20 |

After 20 minutes the system was restarted (see Table 10) and the normalized flux is 1.23 LMH/psig. After about 6 hours running and at the end of the test the normalized flux decreased by 78% to 0.27.

### Example 7

The chilled wastewater stream from Example 3 was filtered using the process described in Example 5 up through the ultrafiltration step. A 100 micron bag filter was used to prefilter the chilled wastewater stream. UF Membrane A (i.e., available from Hydranautics as model JT1) was used to filter the chilled wastewater stream at different feed flowrates with R=1. The results are shown in Table 11. The feed flowrate ranged from 3.7 to 4 gpm, about 2 times that in Example 6. The feed pressure was around 14 psig initially but reached to over 80 psig after about 3 and half hours, while the flux only decreased slightly (see FIG. 8).

TABLE 11
Membrane A on Spray Chill
30 mils feed spacer, Ratio = 1, Circulation = 15 gpm

| Time | Flux | Feed Flowrate | P | T | Norm. Flux |
|---|---|---|---|---|---|
| (min) | (LMH) | (Liter/Hr) | (psig) | (C.) | (liter/m\hat{ }2 · hr · psig) |
| 3 | 31.2 | 940 | 13.6 | 14.4 | 2.29 |
| 5 | 29.3 | 871 | 14.2 | 13.1 | 2.06 |
| 10 | 27.1 | 812 | 15.4 | 10.3 | 1.76 |
| 15 | 24.5 | 727 | 14.9 | 9.3 | 1.65 |
| 30 | 23.6 | 717 | 16.9 | 8.1 | 1.39 |
| 45 | 24.3 | 722 | 18 | 8.2 | 1.35 |
| 60 | 25.1 | 746 | 18.7 | 8.3 | 1.34 |
| 75 | 22.6 | 671 | 17.5 | 8.4 | 1.29 |
| 95 | 27.1 | 807 | 24.2 | 8.4 | 1.12 |
| 105 | 26.6 | 799 | 24.6 | 8.6 | 1.08 |
| 115 | 26.9 | 799 | 25.6 | 8.7 | 1.05 |
| 126 | 26.9 | 809 | 27 | 8.8 | 0.99 |
| 135 | 26.9 | 801 | 29.2 | 8.6 | 0.92 |
| 145 | 26.4 | 779 | 30.4 | 8 | 0.87 |
| 160 | 25.5 | 758 | 32.9 | 8.1 | 0.77 |
| 168 | 28.6 | 855 | 43.4 | 8.1 | 0.66 |
| 180 | 27.7 | 828 | 47.6 | 8.3 | 0.59 |
| 205 | 28.1 | 840 | 82.5 | | 0.34 |
| 207 | 27.7 | 830 | 83.7 | | 0.33 |

Although the chilled wastewater contained less solids in this example than in Example 6, and it was operating only at R=1, the ultrafiltration system had less stabilized running time than in Example 6. This is because the feed flowrate was much higher than in Example 6. In FIG. 8, at the end of the run, the pressure went up rapidly while the flux only had minor decrease.

### Example 8

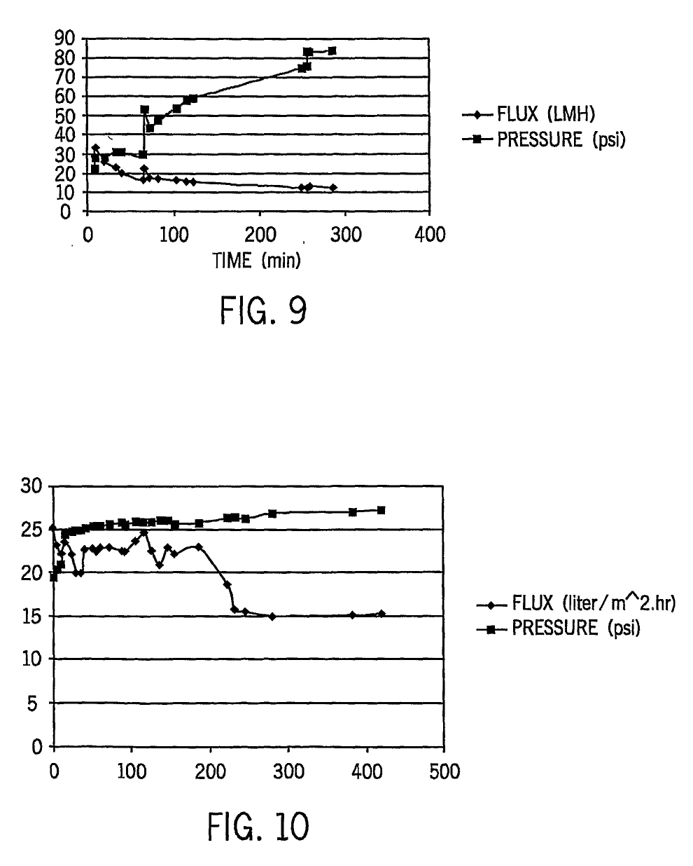

The chilled wastewater stream from Example 3 was filtered using the process described in Example 5 up through the ultrafiltration step. A 100 micron bag filter was used to prefilter the chilled wastewater stream. UF Membrane A (i.e., available from Hydranautics as model JT1) was used to filter the chilled wastewater stream at different feed flowrates with R=4. The feed flowrate was initially 550 liter/hr (2.4 gpm) and decreased to 250 liter·hr (1.1 gpm) at the end of the run. The total run time was less than 5 hours. The results are shown in Table 12. The feed pressure and flux versus time were plotted in FIG. 9. FIG. 9 shows that the flux was 29.7 LMH at the start and that the flux decreased by 58% to 12.4 LMH by the end, and that the feed pressure increased from 23 psig at the beginning of the test to 85 psig at the end of the test. The normalized flux decreased from 1.3 LMH/psig initially to 0.15 LMH/psig in the end (Table 12). From FIG. 9 it can be seen that the pressure behaved differently than in Example 7, shown in FIG. 8. Specifically, the pressure did not go up suddenly at the end of the run, but increased gradually. A light pink color was observed in the permeate of membrane A. A lab analysis using Piece Coomassie blue reagent and BSA standard protein solution found that the protein content in the permeate was 10 ppm.

TABLE 12
Membrane A on Spray Chill
30 mils feed spacer, R = 4, Circulation = 15 gpm

| | | | | | Norm. Flux |
|---|---|---|---|---|---|
| Time | Flux | Feed flow rate | P | T | (liter/ |
| (min) | (liter/m\hat{ }2 · hr) | (Liter/Hr) | (psig) | (C.) | m\hat{ }2 · hr · psig) |
| 8 | 29.7 | 553 | 22.8 | 10.7 | 1.30 |
| 10 | 33.7 | 624 | 28.2 | 10.3 | 1.19 |
| 20 | 26.4 | 494 | 28 | 9.9 | 0.94 |
| 33 | 23.4 | 436 | 32 | 10.1 | 0.74 |
| 40 | 20.5 | 384 | 31.8 | 10.6 | 0.65 |
| 64 | 16.5 | 305 | 29.9 | 11.4 | 0.55 |
| 66 | 22.6 | 417 | 53.6 | 11.3 | 0.42 |
| 72 | 18.3 | 338 | 44.1 | 11.2 | 0.42 |
| 82 | 17.4 | 330 | 48.1 | 11.7 | 0.36 |
| 103 | 16.9 | 313 | 54 | 12.1 | 0.31 |
| 115 | 16.3 | 292 | 58.5 | 12.5 | 0.28 |
| 123 | 15.5 | 286 | 59.5 | 12.3 | 0.26 |
| 250 | 12.8 | 248 | 75 | 14.7 | 0.17 |
| 256 | 12.6 | 243 | 76.3 | | 0.17 |
| 257 | 12.8 | 248 | 83.8 | | 0.15 |
| 259 | 13.0 | 251 | 83.6 | | 0.15 |
| 286 | 12.4 | 253 | 84.2 | | 0.15 |

### Example 9

The chilled wastewater stream from Example 3 was filtered using the process described in Example 5 up through the ultrafiltration step. A 100 micron bag filter was used to prefilter the chilled wastewater stream. UF Membrane B, which is a 10K MWCO UF membrane (i.e., available from Osmonics as model 4040 PW, 47 mils feed spacer, 6.22 m̂2 surface area), was used to filter the chilled wastewater stream at different feed flowrates with R=4. The results are shown in Table 13. The run time was 7 hours. From Table 13, it can be seen that at the end of the run the flux was still over 15 LMH, decreased by 39.7% of the original flux, and the pressure was still at a relatively low level: 27.2 psig. The trend of pressure and flux over time is also shown in FIG. 10.

TABLE 13
Result of Osmonics PW on Spray Chill
47 mils feed spacer, R = 4, Circulation = 25 gpm,

| | | | | | Feed |
|---|---|---|---|---|---|
| Time | Flux | P | T | Norm. Flux | flowrate |
| (min) | (liter/m\hat{ }2 · hr) | (psig) | (C.) | (liter/m\hat{ }2 · hr · psig) | (Liter/Hr) |
| 0 | 25.2 | 19.4 | 12.8 | 1.3 | 398 |
| 5 | 23.2 | 20.4 | 11.2 | 1.14 | 364 |
| 10 | 22.3 | 21 | 11.5 | 1.06 | 346 |
| 15 | 23.5 | 24.3 | 11.3 | 0.97 | 367 |
| 23 | 22.1 | 24.8 | 11.3 | 0.89 | 343 |
| 30 | 20 | 24.9 | 11.2 | 0.8 | 314 |
| 35 | 20 | 25 | 11.3 | 0.8 | 316 |
| 40 | 22.7 | 25.2 | 11.8 | 0.9 | 351 |
| 50 | 22.8 | 25.4 | 13.9 | 0.9 | 348 |
| 55 | 22.6 | 25.5 | 14.3 | 0.89 | 344 |
| 60 | 23 | 25.5 | 14.3 | 0.9 | 350 |
| 71 | 22.9 | 25.7 | 14.2 | 0.89 | 351 |
| 87 | 22.6 | 25.8 | 14.4 | 0.88 | 348 |
| 92 | 22.6 | 25.6 | 14.9 | 0.88 | 347 |
| 105 | 23.6 | 25.9 | 12.6 | 0.91 | 362 |
| 115 | 24.7 | 25.8 | 12.2 | 0.96 | 375 |
| 125 | 22.6 | 25.8 | 13.1 | 0.88 | 349 |
| 135 | 21 | 26.1 | 12.2 | 0.8 | 321 |
| 145 | 23 | 26.1 | 12.6 | 0.88 | 348 |
| 155 | 22.3 | 25.7 | 12.6 | 0.87 | 366 |
| 185 | 23 | 25.8 | 15 | 0.89 | 351 |
| 222 | 18.6 | 26.4 | 12.7 | 0.7 | 273 |
| 232 | 15.8 | 26.5 | 11.7 | 0.6 | 243 |
| 245 | 15.5 | 26.2 | 12.6 | 0.59 | 247 |
| 280 | 14.9 | 26.9 | 12.2 | 0.55 | 224 |
| 383 | 15.1 | 27 | 12.1 | 0.56 | 230 |
| 420 | 15.2 | 27.2 | 15.9 | 0.56 | 230 |

The permeate flux of membrane B is about 1.5 times of that of membrane A under similar operating conditions, as shown in Example 8. No color was observed in the permeate of membrane B. A lab analysis using Piece Coomassie blue reagent and BSA standard protein solution found that the protein content in the permeate was 2 ppm.

### Example 10

The chilled wastewater stream from Example 3 was filtered using the process described in Example 5 up through the ultrafiltration step. A 100 micron bag filter was used to prefilter the chilled wastewater stream. UF membrane B (see Example 9 for information on membrane B) was used to filter the chilled wastewater stream at different feed flowrates. The filtration system was operated at R=1 for 5 hours and then R was increased to 5 and the filtration system was run for another 2 hours. The results are shown in Table 14.

TABLE 14
Result of Osmonics PW on Spray Chill
47 mils feed spacer, Circulation = 25 gpm

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 0 | 30.1 | 15.2 | 11.9 | 1.98 | 1 | 740 |
| 4 | 30.4 | 16.8 | 12.2 | 1.81 | 1 | 753 |
| 9 | 27.1 | 16 | 12.8 | 1.69 | 1 | 705 |
| 14 | 27.5 | 17 | 13.1 | 1.62 | 1 | 691 |
| 19 | 28 | 17.8 | 13.3 | 1.57 | 1 | 700 |
| 29 | 28 | 18.5 | 12.6 | 1.51 | 1 | 697 |
| 34 | 27.3 | 18.4 | 12.8 | 1.48 | 1 | 681 |
| 39 | 27.1 | 18.6 | 12.8 | 1.46 | 1 | 676 |
| 51 | 25.8 | 18.4 | 13.6 | 1.4 | 1 | 641 |
| 62 | 25.1 | 18.7 | 13.6 | 1.34 | 1 | 621 |
| 72 | 24.4 | 18.3 | 13.6 | 1.33 | 1 | 604 |
| 79 | 23.8 | 18.2 | 13.7 | 1.31 | 1 | 590 |
| 89 | 24.9 | 19.5 | 12.8 | 1.28 | 1 | 624 |
| 104 | 24.1 | 19.6 | 13.8 | 1.23 | 1 | 600 |
| 159 | 23.2 | 20.3 | 13.8 | 1.14 | 1 | 583 |
| 184 | 21.5 | 20.3 | 11 | 1.06 | 1 | 537 |
| 232 | 21.4 | 20.9 | 11.3 | 1.02 | 1 | 534 |
| 244 | 21.6 | 21 | 11.6 | 1.03 | 1 | 538 |
| 264 | 21.4 | 21.4 | 11.6 | 1 | 1 | 534 |
| 284 | 20.8 | 20.9 | 10.9 | 1 | 1 | 520 |
| 299 | 22.9 | 23 | 12.7 | 1 | 5 | 344 |
| 314 | 22.1 | 22.6 | 11.6 | 0.98 | 5 | 330 |
| 319 | 22.9 | 24.7 | 13.2 | 0.93 | 5 | 342 |
| 384 | 20.9 | 23.3 | 13.6 | 0.9 | 5 | 311 |
| 399 | 22.5 | 24.6 | 12.5 | 0.91 | 5 | 336 |
| 414 | 22.6 | 25.2 | 12.9 | 0.9 | 5 | 340 |

### Example 11

The chilled wastewater permeate stream from Example 3 was filtered using ultrafiltration membrane A and then filtered using a reverse osmosis membrane C (i.e., Hydranautics ESPA2-4040) using the process shown in Example 5 at R=1. A 100 micron bag filter was used to prefilter the chilled wastewater stream. Reverse osmosis membrane C has a nominal rejection rate of NaCl of 99.6% and a minimum rejection rate of NaCl of 99.4%. The maximum operating pressure and temperature of reverse osmosis membrane C are 600 psig and 113° F., respectively. The maximum feed flow for this membrane is 75 gpm, and the active surface area is 90 ft̂2.

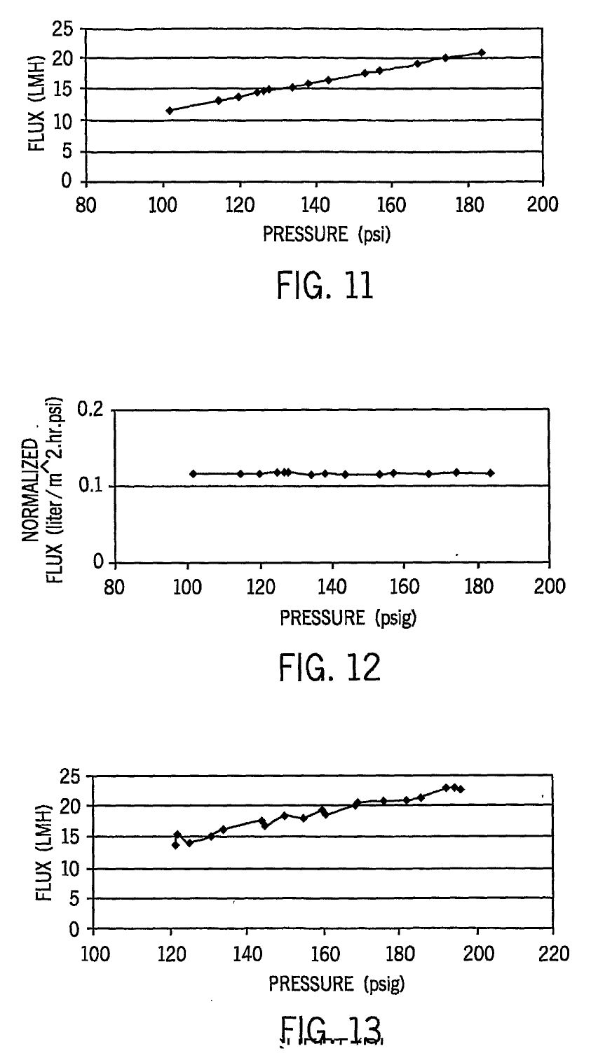

The results are shown in Table 15 of the flux at R=1 under different feed pressures. FIG. 11 shows the relationship between the reverse osmosis membrane flux and the feed pressure. It can be seen from this figure that the flux increases linearly with the feed pressure. The relationship of normalized flux and feed pressure is shown in FIG. 12, and it can be seen that the normalized flux is constant as the pressure increases. This information provides the vergine membrane flux on this feed system.

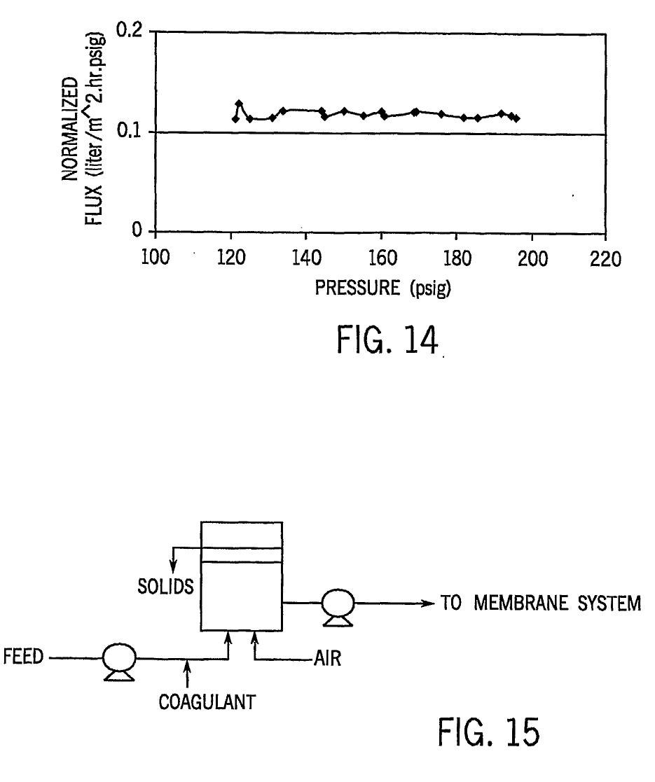

Similarly, Table 15 shows the flux at R=2 under different feed pressures. FIG. 12 shows the relationship between the membrane flux and the feed pressure at R=1, and FIG. 14 shows the relationship of normalized flux and feed pressure at R=2. Almost the same trend can be observed as that at R=1.

TABLE 15
Result of RO Membrane C on UF Membrane A
Permeate of Spray Chill
R = 1

| P (psi) | Flux (LMH) | Norm. Flux (liter/m\hat{ }2 · hr · psi) |
|---|---|---|
| 102 | 11.8 | 0.116 |
| 115 | 13.3 | 0.116 |
| 120 | 13.9 | 0.116 |
| 124.9 | 14.6 | 0.117 |
| 127 | 14.8 | 0.117 |
| 128.2 | 15.1 | 0.118 |
| 134.3 | 15.4 | 0.115 |
| 138.5 | 16.1 | 0.116 |
| 143.9 | 16.6 | 0.115 |
| 153.3 | 17.7 | 0.115 |
| 157.2 | 18.2 | 0.116 |
| 166.9 | 19.2 | 0.115 |
| 174.4 | 20.2 | 0.116 |
| 183.8 | 21 | 0.114 |

### Example 12

The chilled wastewater permeate stream from Example 3 was filtered using ultrafiltration membrane A and then filtered using a reverse osmosis membrane C using the process shown in Example 5 at R=2. A 100 micron bag filter was used to prefilter the chilled wastewater stream.

The results are shown in Table 16 of the flux at R=2 under different feed pressures. FIG. 14 shows the relationship between the reverse osmosis membrane flux and the feed pressure. The trend of the reverse osmosis membrane flux and the feed pressure is similar to that shown in Example 11.

TABLE 16
Result of RO Membrane C on UF Membrane A
Permeate of Spray Chill
R = 2

| P (psig) | Flux (LMH) | Norm. Flux (liter/m\hat{ }2 · hr · psig) |
|---|---|---|
| 121.5 | 13.8 | 0.114 |
| 122.3 | 15.6 | 0.128 |
| 125.4 | 14.3 | 0.114 |
| 131.3 | 15.1 | 0.115 |
| 134.3 | 16.4 | 0.122 |
| 144 | 17.6 | 0.122 |
| 145.1 | 16.9 | 0.116 |
| 150.3 | 18.4 | 0.122 |
| 155.2 | 18.1 | 0.117 |
| 160.3 | 19.4 | 0.121 |
| 161 | 18.7 | 0.116 |
| 168.9 | 20.2 | 0.12 |
| 169.4 | 20.5 | 0.121 |
| 176.1 | 20.7 | 0.118 |
| 182.1 | 21 | 0.115 |
| 185.9 | 21.3 | 0.115 |
| 192.2 | 22.8 | 0.119 |
| 194.5 | 22.8 | 0.117 |
| 195.9 | 22.6 | 0.115 |

### Example 13

The permeate from reverse osmosis membrane C obtained in Examples 11 and 12 was analyzed and compared to the USDA's standards for water reuse. The chemical analysis of the permeate is shown in Table 17, and the USDA's standards are shown in Table 3. In addition, Table 18 shows the microbiology analysis results of the RO permeate. The results of the heterotrophic plate count in Table 18 were not from the same water sample that the coliform and E. coli results were obtained. It is believed that the heterotrophic plate count was skewed due to contamination in the sample that the E. coli and coliform results were obtained so a separate sample was analyzed to obtain the plate count results.

TABLE 17
RO Permeate Chemical Analysis

| Test Name | Result | Units | Method Name | MCL | MDL |
|---|---|---|---|---|---|
| Aluminum, Total | <0.05 | ppm | EPA 200.7 | [0.05-0.2] | |
| Antimony, Total | <0.001 | ppm | EPA 200.8 | 0.006 | 0.001 |
| Arsenic, Total | <0.001 | ppm | EPA 200.8 | 0.05 | 0.001 |
| Barium, Total | <0.005 | ppm | EPA 200.7 | 2.0 | 0.005 |
| Beryllium, Total | <0.001 | ppm | EPA 200.8 | 0.004 | 0.001 |
| Cadmium, Total | <0.0006 | ppm | EPA 200.8 | 0.005 | 0.0003 |
| Calcium | 3.0 | ppm | EPA 200.7 | | 0.002 |
| (Carbonate) | | | | | |
| Chromium, Total | <0.02 | ppm | EPA 200.7 | 0.1 | 0.02 |
| Copper, Total | <0.005 | ppm | EPA 200.7 | 1.3 | 0.005 |
| Fluoride | 0.67 | ppm | SM 4500-F-C | 4.0 | 0.1 |
| Iron, Total | <0.01 | ppm | EPA 200.7 | [0.3] | 0.01 |
| Lead, Total | <0.001 | ppm | EPA 200.8 | 0.015/90% | 0.001 |
| Magnesium, Total | 0.28 | ppm | EPA 200.7 | | 0.02 |
| Manganese, Total | <0.002 | ppm | EPA 200.7 | [0.05] | 0.002 |
| Mercury, Total | <0.0001 | ppm | EPA 245.1 | 0.002 | .0001 |
| Selenium, Total | <0.001 | ppm | EPA 200.8 | 0.05 | 0.001 |
| Silver, Total | <0.0005 | ppm | EPA 200.8 | [0.1] | 0.0004 |
| Thallium, Total | <0.001 | ppm | EPA 200.8 | 0.002 | 0.001 |
| TOC | 56 | ppm | EPA 415.1 | | 2.6 |
| Zinc, Total | <0.01 | ppm | EPA 200.7 | [5.0] | 0.01 |

TABLE 18
RO Permeate Microbiology Analysis

| Test Name | Result | Units | Method Name |
|---|---|---|---|
| Heterotrophic Plate Count | 44 | cfu/ml | |
| Total Coliform MPN | 0 | MPN | |
| E. Coli MPN | 0 | MPN | SM9223 |

### Example 14

The final effluent wastewater stream from Example 4 was filtered using the process described in Example 5 up through the ultrafiltration step. A sand filter was used to prefilter the final effluent wastewater stream. UF membrane D (i.e., Osmonics PW 4040C1027) was used to filter the final effluent wastewater stream at different feed flowrates and concentrations. UF membrane D is a 10K MWCO membrane that has an active area of 67 ft̂2 and a 47 mil feed spacer.

The test was running continuously for over 21 hours. The test was run with the permeate to concentrate ratio (permeate flowrate over concentrate flowrate=R) around 4 for most of the time. However, there was an over 5 hour period during which R was at or above 7. This suggests that UF membrane D is viable to run at higher permeate to concentrate ratio such as 8 continuously for the final effluent wastewater stream. The average feed pressure during the run was less than 12 psig. During the entire test period, the flux was over 20 LMH and there was only minor increase in feed pressure. Thus, the CIP frequency for this process can be less than once a day. The permeate of UF membrane D has a light yellow color which could not be observed in small amounts of the UF membrane D permeate. Table 19 shows the results of UF membrane D when used to filter the final effluent wastewater stream.

TABLE 19
Result of UF Membrane D on Final Effluent
47 mils Spacer, Circulation = 20 gpm

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 0 | 32.6 | 7.2 | 17.3 | 4.53 | 4.9 | 488 |
| 6 | 35 | 7.1 | 17.4 | 4.93 | 4.8 | 526 |
| 13 | 33.1 | 6.8 | 19.4 | 4.87 | 3.5 | 528 |
| 26 | 32.8 | 6.7 | 20.6 | 4.9 | 3.3 | 534 |
| 34 | 24.1 | 5 | 20.9 | 4.82 | 2.75 | 403 |
| 40 | 24.5 | 5.2 | 20.9 | 4.72 | 3 | 406 |
| 45 | 25.4 | 5.5 | 20.9 | 4.62 | 3.5 | 406 |
| 48 | 25.6 | 5.5 | 20.9 | 4.65 | 3.7 | 406 |
| 74 | 25.8 | 5.9 | 20.7 | 4.37 | 3.6 | 411 |
| 87 | 23.4 | 5.4 | 20.7 | 4.33 | 3.3 | 379 |
| 91 | 32.4 | 7.3 | 20.3 | 4.47 | 3.5 | 518 |
| 97 | 30.9 | 7.4 | 21 | 4.2 | 3.4 | 496 |
| 107 | 30.7 | 7.6 | 21.6 | 4.07 | 3.4 | 493 |
| 111 | 35.9 | 8.7 | 21.4 | 4.15 | 3.5 | 575 |
| 117 | 30 | 7.1 | 21.8 | 4.26 | 4.7 | 452 |
| 119 | 28 | 7.2 | 21.8 | 3.89 | 3.8 | 441 |
| 140 | 29.8 | 7.7 | 20.8 | 3.9 | 4.2 | 458 |
| 152 | 27.4 | 7.4 | 20.9 | 3.7 | 4 | 425 |
| 167 | 26.9 | 7.3 | 21.2 | 3.71 | 4.6 | 409 |
| 189 | 26.9 | 7.2 | 21.1 | 3.76 | 4.6 | 409 |
| 464 | 22.6 | 6.9 | 20.5 | 3.28 | 4 | 351 |
| 515 | 23.4 | 7.2 | 20.8 | 3.27 | 4 | 365 |
| 600 | 22.1 | 7.2 | 20.8 | 3.07 | 3 | 365 |
| 638 | 23.9 | 7.6 | 20.8 | 3.17 | 3.6 | 379 |
| 673 | 22.8 | 8.6 | 21.4 | 2.67 | 3.9 | 357 |
| 749 | 21.7 | 8 | 21.7 | 2.71 | 3.8 | 341 |
| 854 | 23.9 | 8.3 | 20.4 | 2.9 | 4.3 | 365 |
| 935 | 21.5 | 7.3 | 21.9 | 2.95 | 5.2 | 319 |
| 939 | 28.5 | 10.2 | 21.9 | 2.81 | 6.7 | 406 |
| 942 | 29.6 | 10.2 | 21.9 | 2.9 | 7.9 | 414 |
| 950 | 28.9 | 9.9 | 22.4 | 2.92 | 8.8 | 400 |
| 1001 | 27.4 | 10 | 22.2 | 2.74 | 8.3 | 381 |
| 1051 | 26.3 | 10.3 | 21.4 | 2.55 | 7.5 | 370 |
| 1076 | 27.2 | 9.7 | 21.3 | 2.82 | 8.8 | 376 |
| 1126 | 23.6 | 8.9 | 21.1 | 2.65 | 7.7 | 332 |
| 1251 | 22.3 | 8.8 | 20.9 | 2.53 | 7.3 | 316 |
| 1266 | 20.4 | 8.1 | 20.8 | 2.53 | 6.6 | 291 |
| 1269 | 19.6 | 7.9 | 20.8 | 2.5 | 4.2 | 303 |
| 1273 | 24.3 | 9.8 | 20.8 | 2.49 | 4.1 | 376 |
| 1276 | 30.7 | 11.8 | 20.4 | 2.61 | 4.5 | 466 |
| 1281 | 28.7 | 11.4 | 20.8 | 2.52 | 4.4 | 439 |
| 1286 | 27.2 | 10.9 | 20.8 | 2.5 | 4.3 | 417 |

### Example 15

The final effluent wastewater stream from Example 4 was filtered using the process described in Example 5 up through the ultrafiltration step. A sand filter was used to prefilter the final effluent wastewater stream. UF membrane E (i.e., Osmonics GK 4040C1024) was used to filter the final effluent wastewater stream at different feed flowrates and concentrations. UF membrane E is a 3.5K MWCO membrane that has an active area of 95 ft̂2 and a 28 mil feed spacer.

The test was run continuously for 33 hours with R being at or around 4 for most of the time. From Table 20, it can be seen that although the flux of UF membrane E is in the range of 10 to 17 most of the time, the normalized flux almost keeps the same level throughout the whole test, which means that the membrane does not show any sign of fouling for over 33 hours running time.

TABLE 20
Result of UF Membrane E on Final Effluent

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 10 | 9.8 | 27 | 19.7 | 0.36 | 1.3 | 311 |
| 14 | 9.7 | 28.8 | 18.5 | 0.34 | 2 | 259 |
| 16 | 12.9 | 37 | 17.8 | 0.35 | 3.5 | 293 |
| 18 | 12.6 | 36.6 | 18 | 0.34 | 3.3 | 291 |
| 20 | 12.3 | 36.6 | 18.2 | 0.34 | 3.1 | 289 |
| 28 | 16.7 | 48.9 | 18.6 | 0.34 | 3.5 | 378 |
| 30 | 16 | 45.2 | 18.6 | 0.35 | 3.9 | 355 |
| 46 | 16.2 | 43.8 | 20.8 | 0.37 | 4 | 358 |
| 101 | 14.3 | 37.5 | 22 | 0.38 | 3.9 | 318 |
| 103 | 13.7 | 36.9 | 22 | 0.37 | 3.9 | 305 |
| 105 | 13.3 | 36.5 | 21.9 | 0.36 | 4.3 | 289 |
| 210 | 14.3 | 38.5 | 22.2 | 0.37 | 4 | 315 |
| 380 | 14.7 | 40 | 21.4 | 0.37 | 4.1 | 321 |
| 440 | 14.5 | 41.2 | 21.2 | 0.35 | 3.9 | 321 |
| 500 | 15.7 | 45.2 | 21.8 | 0.35 | 4.3 | 343 |
| 690 | 13 | 34.7 | 21.2 | 0.37 | 3.7 | 293 |
| 846 | 14 | 38 | 20.7 | 0.37 | 3.5 | 318 |
| 1005 | 12 | 34.7 | 21.1 | 0.35 | 3.4 | 275 |
| 1018 | 11.3 | 31.8 | 21.1 | 0.36 | 3.4 | 259 |
| 1117 | 14.3 | 38.4 | 21.6 | 0.37 | 3.9 | 319 |
| 1160 | 21.9 | 60.4 | 21.7 | 0.36 | 4.3 | 477 |
| 1328 | 20 | 53.1 | 22.4 | 0.38 | 4.5 | 433 |
| 1340 | 12.3 | 34.2 | 22.6 | 0.36 | 3.7 | 278 |
| 1434 | 13.3 | 36.6 | 22.6 | 0.36 | 3.7 | 297 |
| 1473 | 12.3 | 33.4 | 22.2 | 0.37 | 3.8 | 275 |
| 1513 | 12.8 | 34.7 | 21.9 | 0.37 | 3.8 | 286 |
| 1594 | 13.4 | 38.6 | 21.5 | 0.35 | 3.6 | 302 |
| 1963 | 11.9 | 36.2 | 20.2 | 0.33 | 3.2 | 275 |
| 1999 | 12.5 | 38.8 | 20.5 | 0.32 | 3.2 | 289 |

### Example 16

The UF permeate stream from UF membrane D (Example 14) was filtered using reverse osmosis membrane C according to the process shown in Example 5. Table 21 shows the analysis results of permeate from reverse osmosis membrane C. From Table 21, it can be seen that the permeate flux of reverse osmosis membrane C decreased from 20 LMH initially to 1.5 LMH and the average feed pressure increased from 107 psi to 244 psi in about 3 hours. It is possible that the R was too high at some point during the test and the concentration of certain salt(s) in the water went above the solubility limit and scale was forming. The properties of the membrane may also be the reason for the quick fouling.

TABLE 21
Result of Reverse Osmosis Membrane C on Permeate from
UF Membrane D of Final Effluent Wastewater Stream

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 0 | 20.2 | 107 | 21.4 | 0.189 | 2.9 | 455 |
| 15 | 18.6 | 151 | 21.4 | 0.123 | 2.9 | 417 |
| 35 | 10.9 | 167 | 22.1 | 0.065 | 5 | 219 |
| 38 | 9.2 | 191 | 22.3 | 0.048 | 3.9 | 194 |
| 64 | 6.6 | 217 | 22.5 | 0.03 | 0.8 | 252 |
| 77 | 6.4 | 221 | 22.7 | 0.029 | 0.7 | 250 |
| 82 | 7 | 259 | 22.9 | 0.027 | 1.3 | 207 |
| 93 | 6 | 263 | 23.6 | 0.023 | 1.2 | 189 |
| 121 | 3.8 | 203 | 24.4 | 0.019 | 1.7 | 99 |
| 127 | 3.7 | 216 | 24.7 | 0.017 | 2.6 | 85 |
| 131 | 1.9 | 235 | 27.9 | 0.008 | 1.3 | 55 |
| 157 | 1.7 | 239 | 27.9 | 0.007 | 1.3 | 51 |
| 195 | 1.5 | 244 | 27.9 | 0.006 | 1.4 | 45 |

### Example 17

The UF permeate stream from UF membrane E (Example 15) was filtered using reverse osmosis membrane C according to the process shown in Example 5. Table 22 shows the analysis results of the permeate from reverse osmosis membrane C. From Table 22, it can be seen that the permeate flux of reverse osmosis membrane C decreased from 27.7 LMH initially to 4.4 LMH and the average feed pressure increased from 147 psi to 221 psi in about 2 hours.

TABLE 22
Result of Reverse Osmosis Membrane C on UF Membrane E
Permeate of Final Effluent Wastewater Stream

| | | | | Norm. Flux | | Feed |
|---|---|---|---|---|---|---|
| Time | Flux | P | T | (liter/ | | flowrate |
| (min) | (liter/m\hat{ }2 · hr) | (psi) | (C.) | m\hat{ }2 · hr · psi) | R | (Liter/Hr) |
| 0 | 27.7 | 147 | 19.8 | 0.188 | 3.3 | 605 |
| 20 | 13.6 | 121 | 20.9 | 0.112 | 2.7 | 313 |
| 24 | 12.6 | 132 | 21.3 | 0.095 | 2.4 | 298 |
| 85 | 7.9 | 157 | 23.6 | 0.05 | 1.9 | 203 |
| 96 | 7.2 | 199 | 23 | 0.036 | 1.5 | 202 |
| 104 | 6.1 | 203 | 23.2 | 0.03 | 1.9 | 156 |
| 125 | 4.4 | 221 | 24.1 | 0.02 | 1.3 | 129 |

### Example 18

The UF permeate stream from UF membrane E (Example 15) was filtered using nanofiltration membrane F (i.e., Hydranautics ESNA1-LF2) according to the process shown in Example 5. Nanofiltration membrane F has similar properties to Hydranutics ESNA1-LF membrane which has a CaCl2 rejection rate of about 80-93%, nominally about 86%, is made using a composite polyamide polymer, and has a membrane area of about 400 ft2. Table 23 shows the analysis results of the permeate from reverse osmosis membrane C. In this test R=4 and the test was run for about 4 hours. From Table 23, it can be seen that the permeate flux of nanofiltration membrane F permeate did not decrease significantly, but the pressure did increase from 18.7 to 39.4 psig.

TABLE 23
Result of NF Membrane F on UF Membrane E Permeate
of Final Effluent

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 7 | 8.8 | 18.7 | 18.8 | 0.47 | 1.5 | 245 |
| 14 | 10.3 | 22.6 | 19.6 | 0.46 | 3 | 229 |
| 20 | 10.8 | 24.3 | 19.9 | 0.44 | 3.5 | 232 |
| 24 | 12.4 | 27.6 | 19.9 | 0.45 | 3.8 | 262 |
| 37 | 11.9 | 27.1 | 20.3 | 0.44 | 3.8 | 251 |
| 65 | 11.9 | 28.3 | 20.6 | 0.42 | 3.8 | 253 |
| 93 | 11.6 | 30.1 | 20.7 | 0.39 | 4.4 | 237 |
| 97 | 11.4 | 30.3 | 20.7 | 0.38 | 3.9 | 240 |
| 146 | 9.9 | 32.8 | 21.3 | 0.3 | 3.2 | 218 |
| 151 | 10.6 | 36.4 | 21.3 | 0.29 | 4.6 | 215 |
| 158 | 10.1 | 36.4 | 21.3 | 0.28 | 3.9 | 212 |
| 233 | 8.6 | 39.4 | 21.7 | 0.22 | 3.4 | 186 |

### Example 19

The UF permeate stream from UF membrane E (Example 15) was filtered using nanofiltration membrane G (i.e., Hydranautics ESNA1) according to the process shown in Example 5. Nanofiltration membrane G has similar properties to Hydranutics ESNA1-LF membrane which has a CaCl2 rejection rate of about 80-93%, nominally about 86%, is made using a composite polyamide polymer, and has a membrane area of about 400 ft2. Two runs were performed with the results from the first run in Table 24 and the results of the second run in Table 25. R fluctuated between about 5 and 1.3 in the first run, while R was maintained at about 1 in the second run. As shown in Table 24, the flux in run 1 decreased from 13.8 LMH to 4.1 LMH in about 2 and half hours and the pressure increased from 49.5 psi to 156 psi. As shown in Table 25, there was little sign of fouling for 10 hours.

TABLE 24
Result of Nanofiltration Membrane G on UF Membrane E
Permeate of Final Effluent - Run 1

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 0 | 13.8 | 49.5 | 16.7 | 0.279 | 3.7 | 294 |
| 20 | 13.5 | 53.4 | 18.4 | 0.253 | 4.1 | 281 |
| 27 | 12.1 | 57.8 | 18.7 | 0.209 | 3.6 | 259 |
| 36 | 11.1 | 64.2 | 18.8 | 0.173 | 3.1 | 246 |
| 46 | 10.6 | 73.6 | 18.9 | 0.144 | 4.8 | 213 |
| 61 | 10.4 | 116 | 19.6 | 0.09 | 3.7 | 221 |
| 73 | 7.1 | 131 | 20.2 | 0.054 | 2.3 | 169 |
| 88 | 5.8 | 141 | 20.8 | 0.041 | 1.8 | 151 |
| 101 | 5.1 | 145 | 21.3 | 0.035 | 1.6 | 139 |
| 142 | 4.2 | 155 | 22.3 | 0.027 | 1.3 | 123 |
| 160 | 4.1 | 156 | 22.6 | 0.026 | 1.3 | 122 |

TABLE 25
Result of Nanofiltration Membrane G on UF Membrane E
Permeate of Final Effluent - Run 2

| | | | | Norm. Flux | | Feed |
|---|---|---|---|---|---|---|
| Time | Flux | P | T | (liter/ | | flowrate |
| (min) | (liter/m\hat{ }2 · hr) | (psig) | (C.) | m\hat{ }2 · hr · psig) | R | (Liter/Hr) |
| 6 | 6 | 23.9 | 12.3 | 0.251 | 0.8 | 229 |
| 8 | 5.9 | 24.2 | 13.9 | 0.244 | 0.8 | 218 |
| 10 | 6 | 24.8 | 15.3 | 0.242 | 1 | 207 |
| 64 | 8.5 | 31 | 21.7 | 0.274 | 1.2 | 262 |
| 85 | 8 | 30.7 | 21.6 | 0.261 | 1.1 | 262 |
| 120 | 8.6 | 31.1 | 21.6 | 0.277 | 1.1 | 272 |
| 157 | 7.9 | 30.5 | 21.3 | 0.259 | 1.1 | 253 |
| 190 | 7.9 | 30.5 | 21 | 0.259 | 1.1 | 252 |
| 240 | 8 | 30.7 | 20.7 | 0.261 | 1.1 | 264 |
| 310 | 7.9 | 30.6 | 20.6 | 0.258 | 1.1 | 255 |
| 370 | 7.6 | 30.5 | 19.8 | 0.249 | 1 | 250 |
| 393 | 7.8 | 31.2 | 19.6 | 0.25 | 1.1 | 245 |
| 605 | 7.6 | 31.3 | 19.1 | 0.243 | 1.1 | 244 |

### Example 20

The permeate from reverse osmosis membrane C may be analyzed and compared to the USDA's standards for water reuse. The chemical analysis of the permeate is shown in Table 26, and the USDA's standards are shown in Table 3. In addition, Table 27 shows the microbiology analysis results of the permeate. As shown, the permeate meets the USDA's standards for water reuse.

TABLE 26
RO Permeate Chemical Analysis

| Test Name | Result | Units | Method Name | MCL | MDL |
|---|---|---|---|---|---|
| Chloride | 23 | ppm | EPA 300.0 | [250] | |
| Potassium, Total | 17 | ppm | EPA 200.7 | | 0.03 |
| Sodium, Total | 70 | ppm | EPA 200.7 | | 0.2 |
| Solids, Suspended | <10 | ppm | SM 2540 D | [500] | 10 |
| Nickel, Total | <0.03 | ppm | EPA 200.7 | 0.1 | 0.03 |
| Cadmium, Total | <0.0006 | ppm | EPA 200.8 | 0.005 | 0.0003 |
| Calcium | 7 | ppm | EPA 200.7 | | 0.002 |
| (Carbonate) | | | | | |
| Chromium, Total | <0.02 | ppm | EPA 200.7 | 0.1 | 0.02 |
| Iron, Total | <0.01 | ppm | EPA 200.7 | [0.3] | 0.01 |
| Lead, Total | <0.001 | ppm | EPA 200.8 | 0.015/90% | 0.001 |
| Magnesium, Total | 0.57 | ppm | EPA 200.7 | | 0.02 |
| Manganese, Total | <0.002 | ppm | EPA 200.7 | [0.05] | 0.002 |
| Mercury, Total | <0.0001 | ppm | EPA 245.1 | 0.002 | .0001 |
| TOC | 8.5 | ppm | EPA 415.1 | | 1 |

TABLE 27
RO Permeate Microbiology Analysis

| Test Name | Result | Units | Method Name |
|---|---|---|---|
| Heterotrophic Plate Count | <30 | cfu/ml | |
| Total Coliform MPN | 0 | MPN | |
| E. Coli MPN | 0 | MPN | SM9223 |

### Example 21

The chilled wastewater stream from Example 3 may be prefiltered using a dissolved air flocculation system. FIG. 15 shows a process flow diagram of a dissolved air flocculation system that may be used. The dissolved air flocculation system may be used to remove the majority of blood (e.g., blood protein) and other solids in the chilled wastewater.

### Illustrative Embodiments

Reference is made in the following to a number of illustrative embodiments of the subject matter described herein. The following embodiments illustrate only a few selected embodiments that may include the various features, characteristics, and advantages of the subject matter as presently described. Accordingly, the following embodiments should not be considered as being comprehensive of all of the possible embodiments. Also, features and characteristics of one embodiment may and should be interpreted to equally apply to other embodiments or be used in combination with any number of other features from the various embodiments to provide further additional embodiments, which may describe subject matter having a scope that varies (e.g., broader, etc.) from the particular embodiments explained below. Accordingly, any combination of any of the subject matter described herein is contemplated.

According to one embodiment, a method for removal of contaminants from wastewater comprises: passing a wastewater stream through a sand filter or a self cleaning strainer to provide a filtered wastewater stream; passing the filtered wastewater stream through a nanofiltration membrane to produce a nanofiltration permeate and a nanofiltration retentate. The wastewater stream may include poultry blood protein. The wastewater stream may include at least about 200 ppm suspended solids having a particle size that is no more than 1 microns. The wastewater stream may include at least about 100 ppm suspended solids having a particle size that is no more than 0.5 microns. The wastewater stream may include about 30-75 ppm of oil and grease. The method may comprise passing the filtered wastewater stream through a microporous membrane before passing the filtered wastewater stream through the nanofiltration membrane, wherein the microporous membrane has a pore size of about 0.5 to 2 microns and has a filtering surface with a contact angle of no more than about 40 degrees. The nanofiltration membrane may include a polyamide material. The nanofiltration membrane may have a filtering surface with a contact angle of no more than 40 degrees. The nanofiltration membrane may have an MgSO4 rejection rate of at least about 90%. The method may comprise sanitizing the nanofiltration permeate. The temperature of the nanofiltration permeate may be no more than 60° F.

According to another embodiment, a method for removal of contaminants from wastewater comprises: prefiltering a wastewater stream from a poultry processing facility to provide a filtered wastewater stream; passing the filtered wastewater stream through a nanofiltration membrane to produce a nanofiltration permeate and a nanofiltration retentate. Prefiltering the wastewater stream may include passing the wastewater stream through a sand filter. Prefiltering the wastewater stream may include passing the wastewater stream through a polishing filter. Prefiltering the wastewater stream may include passing the wastewater stream through a drum filter. Prefiltering the wastewater stream may include passing the wastewater stream through a dissolved air flotation system. Prefiltering the wastewater stream may include passing the wastewater stream through a self-cleaning strainer. Prefiltering the wastewater stream may include passing the wastewater stream through a microporous membrane to provide a first permeate and a first retentate, wherein the filtered wastewater stream includes the first permeate. The nanofiltration membrane may be a low pressure nanofiltration membrane. The nanofiltration membrane may be a polyamide membrane. The nanofiltration membrane may include a modified polyamide type membrane. The nanofiltration membrane may include a polyamide thin-film composite type membrane. The nanofiltration membrane may have a filtering surface with a contact angle of no more than about 40 degrees. The nanofiltration membrane may have an MgSO4 rejection rate of at least about 90%. The nanofiltration membrane may have an MgSO4 rejection rate of at least about 95%. The nanofiltration membrane may have an MgSO4 rejection rate of at least about 97%. The method may comprise sanitizing the nanofiltration permeate using ozone and/or ultraviolet light. The temperature of the nanofiltration permeate may be no more than 70° F. The temperature of the nanofiltration permeate may be no more than 60° F. The temperature of the nanofiltration permeate may be no more than 55° F. The wastewater stream may comprise poultry blood protein. The wastewater stream may include at least about 200 ppm suspended solids having a particle size that is no more than 1 microns. The wastewater stream may include at least about 100 ppm suspended solids having a particle size that is no more than 0.5 microns. The wastewater stream may include at least about 30 ppm of oil and grease. The wastewater stream may include about 30-75 ppm of oil and grease. The wastewater stream may include about 40-65 ppm of oil and grease.

According to another embodiment, a method for removal of contaminants from wastewater comprises: passing a wastewater stream through a microporous membrane to produce a first permeate and a first retentate; passing the first permeate through a nanofiltration membrane to produce a nanofiltration permeate and a nanofiltration retentate. The microporous membrane may have a pore size of about 0.5 to 2 microns. The microporous membrane may have a filtering surface with a contact angle of no more than about 40 degrees. The microporous member may have a filtering surface with a contact angle of about 35 to 40 degrees. The microporous membrane may be polymeric. The microporous membrane may comprise nylon and/or polypropylene.

According to another embodiment, a method for removal of contaminants from wastewater comprises: passing a wastewater stream through a sand filter or a self cleaning strainer to provide a filtered wastewater stream; passing the filtered Wastewater stream through a microporous membrane to produce a first permeate and a first retentate; passing the first permeate through a nanofiltration membrane to produce a nanofiltration permeate and a nanofiltration retentate. The wastewater stream may include poultry blood protein. The wastewater stream may include at least about 200 ppm suspended solids having a particle size that is no more than 1 microns. The wastewater stream may include at least about 100 ppm suspended solids having a particle size that is no more than 0.5 microns. The wastewater stream may include at least about 30 ppm of oil and grease. The wastewater stream may include about 30-75 ppm of oil and grease. The wastewater stream may include about 40-65 ppm of oil and grease. The microporous membrane may have a pore size of about 0.5 to 2 microns and a filtering surface with a contact angle of no more than about 40 degrees. The microporous membrane may be polymeric and have a filtering surface with a contact angle of no more than about 40 degrees. The microporous membrane may comprise nylon and/or polypropylene. The microporous membrane may have a filtering surface with a contact angle of between about 35 to 40 degrees. The nanofiltration membrane may include a polyamide material. The nanofiltration membrane may have a filtering surface with a contact angle of no more than 40 degrees. The method may comprise sanitizing the nanofiltration permeate. The temperature of the nanofiltration permeate may be no more than 60° F.

According to another embodiment, a method for removal of contaminants from wastewater comprises: passing a wastewater stream including animal manure through a self-cleaning strainer or a sand filter to produce a filtered wastewater stream; passing the filtered wastewater stream through a diatomaceous earth vacuum filtration system to produce a filtrate stream. The wastewater stream may include water runoff from a cattle feedlot. The wastewater stream may passed through the sand filter, wherein the sand filter includes sand having a mesh size that is about 120 to 180 for smaller particles and about 400 to 700 for larger particles. The wastewater stream may include at least about 8,000 ppm suspended solids having a particle size between about 0.1 to 0.5 microns. The filtered wastewater stream may include no more than about 3000 ppm suspended solids. The filtrate stream may include no more than about 100 ppm suspended solids. The diatomaceous earth vacuum filtration system may be a rotary diatomaceous earth vacuum filtration system. The method may comprise applying water from the filtrate stream to ground to prevent dust. The method may comprise passing the filtrate stream through a nanofiltration membrane to produce a nanofiltration permeate and a nanofiltration retentate. The nanofiltration membrane may have a MgSO4 rejection rate of at least about 90% and a filtering surface with a contact angle of no more than 40 degrees. The method may comprise sanitizing the filtrate stream using ozone and/or ultraviolet light.

According to another embodiment, a method for removal of contaminants from wastewater comprises: prefiltering a wastewater stream including animal manure to produce a filtered wastewater stream; passing the filtered wastewater stream through diatomaceous earth to produce a filtrate stream. The animal manure may be cattle manure. The wastewater stream may include water from cattle feedlot runoff water. The wastewater stream may include at least 5,000 ppm suspended solids. The wastewater stream may include at least 8,000 ppm suspended solids. The wastewater stream may include at least 10,000 ppm suspended solids. The wastewater stream may include at least about 5,000 ppm suspended solids having a particle size between about 0.1 to 1 microns. The wastewater stream may include at least about 5,000 ppm suspended solids having a particle size that is no more than about 0.45 microns. The wastewater stream may include at least about 8,000 ppm suspended solids having a particle size between about 0.1 to 1 microns. The wastewater stream may include at least about 8,000 ppm suspended solids having a particle size that is no more than about 0.45 microns. The wastewater stream may include at least about 10,000 ppm suspended solids having a particle size between about 0.1 to 1 microns. The wastewater stream may include at least about 10,000 ppm suspended solids having a particle size that is no more than about 0.45 microns. The wastewater stream may include at least about 11,000 ppm suspended solids having a particle size that is no more than about 0.45 microns. A sand filter may be used to prefilter the wastewater stream. The sand filter may include sand having a mesh size that is about 50 to 200 for smaller particles and about 180 to 800 for larger particles. The sand filter may include sand having a mesh size that is about 120 to 180 for smaller particles and about 400 to 700 for larger particles. The filtered wastewater stream may include no more than about 3000 ppm suspended solids. The filtered wastewater stream may include no more than about 2000 ppm suspended solids. The filtered wastewater may be passed through a diatomaceous earth vacuum filtration system. The filtrate stream may include no more than about 500 ppm suspended solids. The filtrate stream may include no more than about 100 ppm suspended solids. The filtrate stream may include no more than about 10 ppm suspended solids. The method comprise applying water from the filtrate stream to the ground to prevent dust. The method may comprise sanitizing the filtrate stream using ozone and/or ultraviolet light. The method may comprise passing the filtrate stream through a nanofiltration membrane to produce a nanofiltration permeate and a nanofiltration retentate. The filtrate stream may be passed through the nanofiltration membrane under a transmembrane pressure of no more than about 150 psig. The filtrate stream may be passed through the nanofiltration membrane under a transmembrane pressure of no more than about 35 psig. The method nanofiltration membrane may have a filtering surface with a contact angle of no more than about 40 degrees. The nanofiltration membrane may include a polyamide material. The nanofiltration membrane may include a modified polyamide type membrane. The nanofiltration membrane may include a polyamide thin-film composite type membrane. The nanofiltration membrane may be a low pressure nanofiltration membrane. The nanofiltration membrane may have an MgSO4 rejection rate of at least about 90%. The nanofiltration membrane may have an MgSO4 rejection rate of at least about 95%. The nanofiltration membrane may have an MgSO4 rejection rate of at least about 97%.

According to another embodiment, a method for removal of contaminants from wastewater comprises: passing a wastewater stream through a diatomaceous earth vacuum filtration system to produce a filtrate stream; wherein the wastewater stream includes at least about 10,000 ppm suspended solids having a particle size that is no more than about 0.45 microns; and passing the filtrate stream through a nanofiltration membrane to produce a nanofiltration permeate and a nanofiltration retentate.

According to another embodiment, a method for removal of contaminants from wastewater comprises: prefiltering a wastewater stream; passing the prefiltered stream through a diatomaceous earth vacuum filtration system to produce a filtrate stream; and passing the filtrate stream through a nanofiltration membrane to produce a nanofiltration permeate and a nanofiltration retentate; wherein the wastewater stream includes at least about 10,000 ppm suspended solids having a particle size that is no more than about 0.45 microns.

According to another embodiment, a method for removal of contaminants from wastewater comprises: prefiltering a wastewater stream including animal manure to produce a filtered wastewater stream; passing the filtered wastewater stream through a nanofiltration membrane to produce a nanofiltration permeate and a nanofiltration retentate.

According to another embodiment, a method for the removal of contaminants from wastewater comprises: passing a wastewater stream, which includes blood proteins, through a bag filter to provide a filtered wastewater stream; passing the filtered wastewater stream through an ultrafiltration membrane to produce an ultrafiltration permeate and an ultrafiltration retentate; passing the ultrafiltration permeate through a reverse osmosis membrane to produce a first permeate and a second retentate. The bag filter may include pores that are no larger than 10 microns. The wastewater stream may include at least about 500 ppm blood proteins. The wastewater stream may have a temperature of no more than 70° F. The wastewater stream may include at least about 400 ppm of suspended solids. The wastewater stream may have a bicarbonate alkalinity of about 300-350 ppm. The flux rate of the ultrafiltration permeate through the ultrafiltration membrane is between approximately 500 ml/hr*m2*psig and 1300 ml/hr*m2*psig. The ultrafiltration membrane may have a molecular weight cutoff at 50 psig of no more than 10K. The ultrafiltration permeate may have a protein content of no more than about 15 ppm. The ultrafiltration permeate may include no more than about 10 ppm of suspended solids. The flux rate of the first permeate through the reverse osmosis membrane may be between approximately 80 ml/hr*m2*psig and 120 ml/hr*m2*psig.

According to another embodiment, a method for removal of contaminants from wastewater comprises: prefiltering a wastewater stream which includes blood proteins; passing the prefiltered stream through an ultrafiltration membrane to produce an ultrafiltration permeate and an ultrafiltration retentate; passing the ultrafiltration permeate through a reverse osmosis membrane to produce a reverse osmosis permeate and a reverse osmosis retentate.

According to another embodiment, a method for removal of contaminants from wastewater comprises: passing a wastewater stream from a carcass processing facility through a prefilter to provide a filtered wastewater stream; and passing the filtered wastewater stream through a reverse osmosis membrane and/or nanofiltration membrane to produce a first permeate and a first retentate. The wastewater stream may include blood proteins. The wastewater stream may include bovine blood proteins. The wastewater stream may include at least about 500 ppm blood proteins. The wastewater stream may have a temperature of no more than 70° F. The wastewater stream may have a temperature of no more than 50° F. The wastewater stream may include at least about 400 ppm of suspended solids. The wastewater stream may include at least about 10 ppm of oil and grease. The wastewater stream may include a final effluent wastewater stream. The wastewater stream may include a chilled wastewater stream. Prefiltering the wastewater stream may include passing the wastewater stream through a self-cleaning strainer. Prefiltering the wastewater stream may include passing the wastewater stream through a dissolved gas flotation cell. Prefiltering the wastewater stream may include passing the wastewater stream through a bag filter. The bag filter may include pores that are no more than about 20 microns in size. The bag filter may include pores that are no more than about 50 microns in size. Prefiltering the wastewater stream may include passing the wastewater stream through a mesh screen. Prefiltering the wastewater stream may include passing the wastewater stream through an ultrafiltration membrane. The ultrafiltration membrane may have a molecular weight cutoff at 50 psig of no more than a 10K. The ultrafiltration permeate may have a protein content of no more than about 15 ppm. The ultrafiltration permeate may have a protein content of no more than about 10 ppm. The ultrafiltration permeate may have a protein content of no more than about 5 ppm. The flux rate of a permeate through the ultrafiltration membrane is between approximately 500 ml/hr*m2*psig and 1300 ml/hr*m2*psig. The filtered wastewater stream may pass through a reverse osmosis membrane. The reverse osmosis membrane may include a polyamide material. The reverse osmosis membrane may have a NaCl rejection rate of at least about 99%. The first permeate may have a total plate count of no more than about 500 cfu/ml. The turbidity of no more than about 5% of samples of the first permeate may be more than 1 NTU. The flux rate of the first permeate is between approximately 80 ml/hr*m2*psig and 120 ml/hr*m2*psig. The filtered wastewater stream may pass through a nanofiltration membrane. The first permeate may have a temperature of no more than 70° F. The first permeate may have a temperature of no more than 60° F. The first permeate may have a temperature of no more than 55° F.

According to another embodiment, a method for removal of contaminants from wastewater comprises: passing a wastewater stream through at least one dissolved gas flotation cell to provide an effluent stream and a flotation solids stream; passing the effluent stream through an alkaline bed to provide an alkaline treated effluent stream; passing the alkaline treated effluent stream through an ultrafiltration membrane to produce an ultrafiltration permeate and an ultrafiltration retentate; and passing the ultrafiltration permeate through a reverse osmosis membrane and/or nanofiltration membrane to produce a first permeate and a first retentate. The wastewater stream may include blood proteins. The wastewater stream may pass through a dissolved gas flotation cell after adding a flocculation agent. The flocculation agent may comprise alum and/or limestone. The alkaline bed may include calcium carbonate, calcium hydroxide, and/or calcium oxide.

According to another embodiment, a method for removal of contaminants from wastewater comprises: passing a wastewater stream through a sand filter or a self cleaning strainer to provide a filtered wastewater stream; passing the filtered wastewater stream through a nanofiltration membrane to produce a nanofiltration permeate and a nanofiltration retentate. The wastewater stream may include poultry blood protein. The wastewater stream may include at least about 200 ppm suspended solids having a particle size that is no more than 1 microns. The wastewater stream may include at least about 100 ppm suspended solids having a particle size that is no more than 0.5 microns. The wastewater stream may include about 30-75 ppm of oil and grease. The method may comprise passing the filtered wastewater stream through a microporous membrane before passing the filtered wastewater stream through the nanofiltration membrane, wherein the microporous membrane has a pore size of about 0.5 to 2 microns and has a filtering surface with a contact angle of no more than about 40 degrees. The nanofiltration membrane may include a polyamide material. The nanofiltration membrane may have a filtering surface with a contact angle of no more than 40 degrees. The nanofiltration membrane may have an MgSO4 rejection rate of at least about 90%. The method may comprise sanitizing the nanofiltration permeate. The temperature of the nanofiltration permeate may be no more than 60° F.

According to another embodiment, a method for removal of contaminants from wastewater comprises: prefiltering a wastewater stream from a poultry processing facility to provide a filtered wastewater stream; passing the filtered wastewater stream through a nanofiltration membrane to produce a nanofiltration permeate and a nanofiltration retentate. Prefiltering the wastewater stream may include passing the wastewater stream through a sand filter. Prefiltering the wastewater stream may include passing the wastewater stream through a polishing filter. Prefiltering the wastewater stream may include passing the wastewater stream through a drum filter. Prefiltering the wastewater stream may include passing the wastewater stream through a dissolved air flotation system. Prefiltering the wastewater stream may include passing the wastewater stream through a self-cleaning strainer. Prefiltering the wastewater stream may include passing the wastewater stream through a microporous membrane to provide a first permeate and a first retentate, wherein the filtered wastewater stream includes the first permeate. The nanofiltration membrane may be a low pressure nanofiltration membrane. The nanofiltration membrane may include a polyamide material. The nanofiltration membrane may include a modified polyamide type membrane. The nanofiltration membrane may include a polyamide thin-film composite type membrane. The nanofiltration membrane may have a filtering surface with a contact angle of no more than about 40 degrees. The nanofiltration membrane may have an MgSO4 rejection rate of at least about 90%. The nanofiltration membrane may have an MgSO4 rejection rate of at least about 95%. The nanofiltration membrane may have an MgSO4 rejection rate of at least about 97%. The method may comprise sanitizing the nanofiltration permeate using ozone and/or ultraviolet light. The temperature of the nanofiltration permeate may be no more than 70° F. The temperature of the nanofiltration permeate may be no more than 60° F. The temperature of the nanofiltration permeate may be no more than 55° F. The wastewater stream may comprise poultry blood protein. The wastewater stream may include at least about 200 ppm suspended solids having a particle size that is no more than 1 microns. The wastewater stream may include at least about 100 ppm suspended solids having a particle size that is no more than 0.5 microns. The wastewater stream may include at least about 30 ppm of oil and grease. The wastewater stream may include about 30-75 ppm of oil and grease. The wastewater stream may include about 40-65 ppm of oil and grease.

According to another embodiment, a method for removal of contaminants from wastewater comprises: passing a wastewater stream through a microporous membrane to produce a first permeate and a first retentate; passing the first permeate through a nanofiltration membrane to produce a nanofiltration permeate and a nanofiltration retentate. The microporous membrane may have a pore size of about 0.5 to 2 microns. The microporous membrane may have a filtering surface with a contact angle of no more than about 40 degrees. The microporous member may have a filtering surface with a contact angle of about 35 to 40 degrees. The microporous membrane may be polymeric. The microporous membrane may comprise nylon and/or polypropylene.

According to another embodiment, a method for removal of contaminants from wastewater comprises: passing a wastewater stream through a sand filter or a self cleaning strainer to provide a filtered wastewater stream; passing the filtered wastewater stream through a microporous membrane to produce a first permeate and a first retentate; passing the first permeate through a nanofiltration membrane to produce a nanofiltration permeate and a nanofiltration retentate. The wastewater stream may include poultry blood protein. The wastewater stream may include at least about 200 ppm suspended solids having a particle size that is no more than 1 microns. The wastewater stream may include at least about 100 ppm suspended solids having a particle size that is no more than 0.5 microns. The wastewater stream may include at least about 30 ppm of oil and grease. The wastewater stream may include about 30-75 ppm of oil and grease. The wastewater stream may include about 40-65 ppm of oil and grease. The microporous membrane may have a pore size of about 0.5 to 2 microns and a filtering surface with a contact angle of no more than about 40 degrees. The microporous membrane may be polymeric and may have a filtering surface with a contact angle of no more than about 40 degrees. The microporous membrane may comprise nylon and/or polypropylene. The microporous membrane may have a filtering surface with a contact angle of between about 35 to 40 degrees. The nanofiltration membrane may include a polyamide material. The nanofiltration membrane may have a filtering surface with a contact angle of no more than 40 degrees. The method may comprise sanitizing the nanofiltration permeate. The temperature of the nanofiltration permeate may be no more than 60° F.

According to another embodiment, a method for removal of contaminants from wastewater comprises: passing a wastewater stream including animal manure through a self-cleaning strainer or a sand filter to produce a filtered wastewater stream; passing the filtered wastewater stream through a diatomaceous earth vacuum filtration system to produce a filtrate stream. The wastewater stream may include water runoff from a cattle feedlot. The wastewater stream may be passed through the sand filter, wherein the sand filter includes sand having a mesh size that is about 120 to 180 for smaller particles and about 400 to 700 for larger particles. The wastewater stream may include at least about 8,000 ppm suspended solids having a particle size between about 0.1 to 0.5 microns. The filtered wastewater stream may include no more than about 3000 ppm suspended solids. The filtrate stream may include no more than about 100 ppm suspended solids. The diatomaceous earth vacuum filtration system may be a rotary diatomaceous earth vacuum filtration system. The method may comprise applying water from the filtrate stream to ground to prevent dust. The method may comprise passing the filtrate stream through a nanofiltration membrane to produce a nanofiltration permeate and a nanofiltration retentate. The nanofiltration membrane may have an MgSO4 rejection rate of at least about 90% and a filtering surface with a contact angle of no more than 40 degrees. The method may comprise sanitizing the filtrate stream using ozone and/or ultraviolet light.

According to another embodiment, a method for removal of contaminants from wastewater comprises: prefiltering a wastewater stream including animal manure to produce a filtered wastewater stream; passing the filtered wastewater stream through diatomaceous earth to produce a filtrate stream. The animal manure may be cattle manure. The wastewater stream may include cattle feedlot runoff water. The wastewater stream may include at least 5,000 ppm suspended solids. The wastewater stream may include at least 8,000 ppm suspended solids. The wastewater stream may include at least 10,000 ppm suspended solids. The wastewater stream may include at least about 5,000 ppm suspended solids having a particle size between about 0.1 to 1 microns. The wastewater stream may include at least about 5,000 ppm suspended solids having a particle size that is no more than about 0.45 microns. The wastewater stream may include at least about 8,000 ppm suspended solids having a particle size between about 0.1 to 1 microns. The wastewater stream may include at least about 8,000 ppm suspended solids having a particle size that is no more than about 0.45 microns. The wastewater stream may include at least about 10,000 ppm suspended solids having a particle size between about 0.1 to 1 microns. The wastewater stream may include at least about 10,000 ppm suspended solids having a particle size that is no more than about 0.45 microns. The wastewater stream may include at least about 11,000 ppm suspended solids having a particle size that is no more than about 0.45 microns. A sand filter may be used to prefilter the wastewater stream. The sand filter may include sand having a mesh size that is about 50 to 200 for smaller particles and about 180 to 800 for larger particles. The sand filter may include sand having a mesh size that is about 120 to 180 for smaller particles and about 400 to 700 for larger particles. The filtered wastewater stream may include no more than about 3000 ppm suspended solids. The filtered wastewater stream may include no more than about 2000 ppm suspended solids. The filtered wastewater may be passed through a diatomaceous earth vacuum filtration system. The filtrate stream may include no more than about 500 ppm suspended solids. The filtrate stream may include no more than about 100 ppm suspended solids. The filtrate stream may include no more than about 10 ppm suspended solids. The method may comprise applying water from the filtrate stream to the ground to prevent dust. The method may comprise sanitizing the filtrate stream using ozone and/or ultraviolet light. The method may comprise passing the filtrate stream through a nanofiltration membrane to produce a nanofiltration permeate and a nanofiltration retentate. The filtrate stream may be passed through the nanofiltration membrane under a transmembrane pressure of no more than about 150 psig. The filtrate stream may be passed through the nanofiltration membrane under a transmembrane pressure of no more than about 35 psig. The nanofiltration membrane may have a filtering surface with a contact angle of no more than about 40 degrees. The nanofiltration membrane may include a polyamide material. The nanofiltration membrane may include a modified polyamide type membrane. The nanofiltration membrane may include a polyamide thin-film composite type membrane. The nanofiltration membrane may be a low pressure nanofiltration membrane. The nanofiltration membrane may have an MgSO4 rejection rate of at least about 90%. The nanofiltration membrane may have an MgSO4 rejection rate of at least about 95%. The nanofiltration membrane may have an MgSO4 rejection rate of at least about 97%.

According to another embodiment, a method for removal of contaminants from wastewater comprises: passing a wastewater stream through a diatomaceous earth vacuum filtration system to produce a filtrate stream; wherein the wastewater stream includes at least about 10,000 ppm suspended solids having a particle size that is no more than about 0.45 microns; and passing the filtrate stream through a nanofiltration membrane to produce a nanofiltration permeate and a nanofiltration retentate.

According to another embodiment, a method for removal of contaminants from wastewater comprises: prefiltering a wastewater stream; passing the prefiltered stream through a diatomaceous earth vacuum filtration system to produce a filtrate stream; and passing the filtrate stream through a nanofiltration membrane to produce a nanofiltration permeate and a nanofiltration retentate; wherein the wastewater stream includes at least about 10,000 ppm suspended solids having a particle size that is no more than about 0.45 microns.

According to another embodiment, a method for removal of contaminants from wastewater comprises: prefiltering a wastewater stream including animal manure to produce a filtered wastewater stream; passing the filtered wastewater stream through a nanofiltration membrane to produce a nanofiltration permeate and a nanofiltration retentate.

According to another embodiment, a method for the removal of contaminants from wastewater comprises: passing a wastewater stream, which includes blood proteins, through a bag filter to provide a filtered wastewater stream; passing the filtered wastewater stream through an ultrafiltration membrane to produce an ultrafiltration permeate and an ultrafiltration retentate; passing the ultrafiltration permeate through a reverse osmosis membrane to produce a first permeate and a second retentate. The bag filter may have pores that are no larger than 10 microns. The wastewater stream may include at least about 500 ppm blood proteins. The wastewater stream may have a temperature of no more than 70° F. The wastewater stream may include at least about 400 ppm of suspended solids. The wastewater stream may have a bicarbonate alkalinity of about 300-350 ppm. The flux rate of the ultrafiltration permeate through the ultrafiltration membrane may be between approximately 500 ml/hr*m2*psig and 1300 ml/hr*m2*psig. The ultrafiltration membrane may have a molecular weight cutoff at 50 psig of no more than 10K. The ultrafiltration permeate may have a protein content of no more than about 15 ppm. The ultrafiltration permeate may include no more than about 10 ppm of suspended solids. The flux rate of the first permeate through the reverse osmosis membrane may be between approximately 80 ml/hr*m2*psig and 120 ml/hr*m2*psig.

According to another embodiment, a method for removal of contaminants from wastewater comprises: prefiltering a wastewater stream which includes blood proteins; passing the prefiltered stream through an ultrafiltration membrane to produce an ultrafiltration permeate and an ultrafiltration retentate; passing the ultrafiltration permeate through a reverse osmosis membrane to produce a reverse osmosis permeate and a reverse osmosis retentate.

According to another embodiment, a method for removal of contaminants from wastewater comprises: passing a wastewater stream from a carcass processing facility through a prefilter to provide a filtered wastewater stream; and passing the filtered wastewater stream through a reverse osmosis membrane and/or nanofiltration membrane to produce a first permeate and a first retentate. The wastewater stream may include blood proteins. The wastewater stream may include bovine blood proteins. The wastewater stream may include at least about 500 ppm blood proteins. The wastewater stream may have a temperature of no more than 70° F. The wastewater stream may have a temperature of no more than 50° F. The wastewater stream may include at least about 400 ppm of suspended solids. The wastewater stream may include at least about 10 ppm of oil and grease. The wastewater stream may include a final effluent wastewater stream. The wastewater stream may include a chilled wastewater stream. Prefiltering the wastewater stream may include passing the wastewater stream through a self-cleaning strainer. Prefiltering the wastewater stream may include passing the wastewater stream through a dissolved gas flotation cell. Prefiltering the wastewater stream may include passing the wastewater stream through a bag filter. The bag filter may include pores that are no more than about 20 microns in size. The bag filter may include pores that are no more than about 50 microns in size. Prefiltering the wastewater stream may include passing the wastewater stream through a mesh screen. Prefiltering the wastewater stream may include passing the wastewater stream through an ultrafiltration membrane. The ultrafiltration membrane may have a molecular weight cutoff at 50 psig of no more than a 10K. The ultrafiltration permeate may have a protein content of no more than about 15 ppm. The ultrafiltration permeate may have a protein content of no more than about 10 ppm. The ultrafiltration permeate may have a protein content of no more than about 5 ppm. A nominal flux rate of a permeate through the ultrafiltration membrane may be between approximately 500 ml/hr*m2*psig and 1300 ml/hr*m2*psig. The filtered wastewater stream may pass through a reverse osmosis membrane. The reverse osmosis membrane may include a polyamide material. The reverse osmosis membrane may have a NaCl rejection rate of at least about 99%. The first permeate may have a total plate count of no more than about 500 cfu/ml. The turbidity of no more than about 5% of samples of the first permeate are more than 1 NTU. The flux rate of the first permeate may be between approximately 80 ml/hr*m2*psig and 120 ml/hr*m2*psig. The filtered wastewater stream may pass through a nanofiltration membrane. The first permeate may have a temperature of no more than 70° F. The first permeate may have a temperature of no more than 60° F. The first permeate may have a temperature of no more than 55° F.

According to another embodiment, a method for removal of contaminants from wastewater comprises: passing a wastewater stream through at least one dissolved gas flotation cell to provide an effluent stream and a flotation solids stream; passing the effluent stream through an alkaline bed to provide an alkaline treated effluent stream; passing the alkaline treated effluent stream through an ultrafiltration membrane to produce an ultrafiltration permeate and an ultrafiltration retentate; and passing the ultrafiltration permeate through a reverse osmosis membrane and/or nanofiltration membrane to produce a first permeate and a first retentate. The wastewater stream may include blood proteins. The wastewater stream may be passed through a dissolved gas flotation cell after adding a flocculation agent. The flocculation agent may comprise alum and/or limestone. The alkaline bed may include calcium carbonate, calcium hydroxide, and/or calcium oxide.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., common use and/or technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Accordingly, the claims are not tied and should not be interpreted to be tied to any particular embodiment, feature, or combination of features other than those explicitly recited in the claims, even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing Figures. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification are understood as modified in all instances by the term “about.” At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10). Further, any value which is within 0-50% above or below a particular data point provided in the Examples or illustrative embodiments should be understood as being supported herein.

1-17. (canceled)

18. A method for removal of contaminants from wastewater comprising:
prefiltering a wastewater stream from a carcass processing facility to provide a filtered wastewater stream;
passing the filtered wastewater stream through a nanofiltration membrane to produce a nanofiltration permeate and a nanofiltration retentate; and
sanitizing the nanofiltration permeate.

19. The method of claim 18 wherein the carcass processing facility is a poultry processing facility.

20. The method of claim 18 wherein the wastewater stream includes at least about 200 ppm suspended solids having a particle size of no more than 1 micron.

21. The method of claim 18 wherein the nanofiltration membrane has an MgSO4 rejection rate of at least about 90%.

22. The method of claim 18 wherein the nanofiltration membrane has a filtering surface with a contact angle of no more than about 40 degrees.

23. The method of claim 18 wherein the nanofiltration membrane includes a polyamide material.

24. The method of claim 18 wherein prefiltering the wastewater stream includes passing the wastewater stream through a sand filter.

25. The method of claim 18 wherein sanitizing the nanofiltration permeate comprises exposing the nanofiltration permeate to ultraviolet light.

26. The method of claim 18 wherein sanitizing the nanofiltration permeate comprises treating the nanofiltration permeate with ozone.

27. The method of claim 18 wherein the temperature of the nanofiltration permeate is no more than about 70° F.

28. The method of claim 18 wherein the wastewater stream is chilled wastewater stream having a temperature no more than about 55° F.

29. The method of claim 18 wherein the wastewater stream includes at least about 30 ppm oil, grease or a mixture thereof.

30. The method of claim 18 wherein the prefiltered wastewater stream is passed through the nanofiltration membrane under a transmembrane pressure of no more than about 150 psig.

31. The method of claim 18 wherein the wastewater stream includes blood proteins.

32. The method of claim 18 wherein the wastewater stream includes at least about 500 ppm blood proteins and at least about 1000 ppm suspended solids having a particle size less than 1 micron.

33. The method of claim 18 wherein the membrane is an asymmetrical membrane having a pore size of no more than about 0.002 micron.

34. The method of claim 33 wherein the membrane has an MgSO4 rejection rate of at least about 90%.

35. The method of claim 18 wherein prefiltering the wastewater stream comprises passing the wastewater stream through a diatomaceous earth filter.

36. The method of claim 18 wherein prefiltering the wastewater stream comprises passing the wastewater stream through a bag filter.

37. The method of claim 18 wherein prefiltering the wastewater stream comprises passing the wastewater stream through a microfiltration membrane.

38. A method for removal of contaminants from wastewater comprising:
prefiltering a wastewater stream;
passing the prefiltered stream through an ultrafiltration membrane to produce an ultrafiltration permeate and an ultrafiltration retentate;
passing the ultrafiltration permeate through a reverse osmosis membrane to produce a reverse osmosis permeate and a reverse osmosis retentate.

39. A method for removal of contaminants from wastewater comprising:
passing a wastewater stream from a carcass processing facility through a prefilter to provide a filtered wastewater stream; and
passing the filtered wastewater stream through a reverse osmosis membrane and/or nanofiltration membrane to produce a first permeate and a first retentate.

40. A method for removal of contaminants from wastewater comprising:
passing a wastewater stream through a diatomaceous earth vacuum filtration system to produce a filtrate stream; wherein the wastewater stream includes at least about 10,000 ppm suspended solids having a particle size that is no more than about 0.45 microns; and
passing the filtrate stream through a nanofiltration membrane to produce a nanofiltration permeate and a nanofiltration retentate.

41. A method for removal of contaminants from wastewater comprising:
prefiltering a wastewater stream to produce a filtered wastewater stream, wherein the wastewater stream includes animal manure, blood proteins or a mixture thereof;
passing the filtered wastewater stream through diatomaceous earth to produce a filtrate stream.
